(19) United States
(12) Patent Application Publication
(10) Pub. No.: US 2011/0318717 A1
(43) Pub. Date: Dec. 29, 2011

(54) Personalized Food Identification and Nutrition Guidance System

(76) Inventor: Laurent Adamowicz, Cambridge, MA (US)

(21) Appl. No.: 12/954,881

(22) Filed: Nov. 28, 2010

Related U.S. Application Data
(60) Provisional application No. 61/357,655, filed on Jun. 23, 2010.

(51) Int. Cl. G09B 19/00

(52) U.S. Cl. 434/127

(57) ABSTRACT

A user presents a food item to a device. In response, the device provides the user with advice about whether or not to eat the food item. The advice is also based on personalized food preferences or restrictions and medical conditions of the user. The advice may also be based on food-related data obtained from other users, such as personalized food preferences, restrictions, medical conditions, and food intake histories of such users. The user may accept or reject the advice provided to the user by the system. If the user rejects the advice, the device may identify one or more alternative food items within the vicinity of the device or any other location requested by the user and provide the user with advice about whether or not to eat the alternative food items. The user may accept or reject this alternative advice.

### CROSS-REFERENCE TO RELATED APPLICATIONS

This application claims priority from U.S. Provisional Patent Application Ser. No. 61/357,655, filed on Jun. 23, 2010, entitled, “Personalized Food Identification and Nutrition Guidance System,” which is hereby incorporated by reference herein.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND

Many systems exist for assisting people in eating healthy food and otherwise keeping to a prescribed diet. Such systems, however, have a variety of limitations. For example, some systems advise the user to eat a diet consisting of foods that are appropriate for a general category of user, but not necessarily for the particular user. As another example, existing systems typically require the user to manually input a variety of data, such as the food that the user eats throughout the day and the exercise that the user has engaged in throughout the day. As a result of these and other limitations, the advice that such systems provide to a particular user about which food to eat often is not tailored sufficiently to the needs and desires of that user, and often does not reflect current information about the user. Other existing systems provide maps locating restaurants and stores that are not sufficiently tailored to the personal needs of the users. For these and other reasons, users often experiment with such systems for a short period of time, find that such systems do not provide sufficient benefits, and then discontinue use of the systems.

What is needed, therefore, are improved techniques for providing people with food-related advice.

### SUMMARY

A user presents a food item to a device. In response, the device provides the user with advice about whether or not to eat the food item. The user may accept or reject the advice. If the user rejects the advice, the device may identify one or more alternative food items within the vicinity of the device and provide the user with advice about whether or not to eat the alternative food items. The user may accept or reject this alternative advice.

The user may present the food item to the device in any of a variety of ways. For example, the user may present the food item to the device in any one or more of the following ways:
use the device to type or select a name or other description of the food item;
speak a name or other description of the food item into the device;
use the device to read a radio frequency identification (RFID) tag or bar code attached to or otherwise associated with the food item;
use the device to photograph the food item;
use the device to “smell” the food item.

The advice may be developed based on personalized food data associated with the user so that the advice is customized to the particular needs and preferences of the user. The user's personalized food data may include, for example, medical information about the user (such as the user's food-related allergies and medical conditions), the user's food intake history, the user's food preferences and food intolerances (such as whether the user is lactose-intolerant), and the user's current geographic location.

The advice may include a recommendation to eat the food item presented by the user, or a recommendation not to eat the food item presented by the user. Such recommendations may be directed to the entire food item or to portions of it. For example, the device may advise the user to eat one portion of the food item, but advise the user not to eat another portion of the food item.

As mentioned above, if the user rejects the initial advice provided by the device, the device may identify one or more alternative food items within the vicinity of the device. The device may identify such alternative food items in any of a variety of ways, such as by reading RFID tags associated with food items within the vicinity of the device, smelling food items within the vicinity of the device, or retrieving data from an internal or external geo-referenced food database.

The device may identify the user's current location in any of a variety of ways, such as by using a global positioning system (GPS) module within the device. Once the user's current location is identified, the device may correlate such location with the locations of food items to identify food items that are within the vicinity of the user's current location.

The device may identify alternative food items based at least in part on the user's personalized food data. For example, the device may identify food within the vicinity of the user's current or projected location, that is not harmful for the user to eat, based on the user's known allergies and other medical conditions. As another example, the device may identify within the vicinity of the user's current or projected location, the user's favorite foods as labeled in the user's personalized food data.

Associated with the user may be one or more maximum periodical nutritional intake amounts, such as a maximum recommended daily intake of calories, proteins, fiber, salt, sugar, and “bad” fat (which, as used herein, shall refer to saturated fat and trans fat). The device may store or otherwise have access to these amounts. Furthermore, the device may store or otherwise have access to the amount of calories, proteins, fiber, salt, sugar, and bad fat (or other tracked quantities) which the user has already consumed within the current period (e.g., day). The device may inform the user of these values, such as by displaying a chart of the user's maximum and currently-consumed calories, proteins, fiber, salt, sugar, and bad fat. The device may develop the advice mentioned above based at least in part on the impact of eating a particular food item on the user's current nutritional intake amounts. For example, the device may advise the user not to eat a particular food item if doing so would cause the user to exceed her or his maximum daily recommended intake of salt.

The device may store a record of the user's decision to accept or reject the device's advice. More generally, the device may record the food eaten by the user within the user's food intake history.

The device may, when developing the advice for the user, take into account food-related data associated with other users, such as the personalized food data, food intake history, and geographic locations of such users. Similarly, the device may use data associated with the current user to develop food-related advice for other users.

More specifically, in one embodiment a computer-implemented method is performed which includes: (1) receiving input from a user representing a presentation from the user of an initial food item within the vicinity of a particular location; (2) using a device to: (a) sense the initial food item; and (b) develop food identification data descriptive of the initial food item; and (3) developing initial personalized nutrition advice for the user related to the initial food item, based on at least one of: (a) the food identification data; and (b) personalized food data associated with the user.

In another embodiment, a computer-implemented method is performed which includes: (1) identifying first personalized food data of a first user associated with a first device; (2) identifying second personalized food data of at least one second user associated with at least one second device; and (3) developing, based on the first and second personalized food data, a database containing data representing the first personalized food data and the second personalized food data.

Other features and advantages of various aspects and embodiments of the present invention will become apparent from the following description and from the claims.

### BRIEF DESCRIPTION OF THE DRAWINGS

FIG. 1 is a dataflow diagram of a system for providing personalized nutrition advice to a user according to one embodiment of the present invention;

FIG. 2 is a flowchart of a method performed by the system of FIG. 1 according to one embodiment of the present invention;

FIG. 3 is a dataflow diagram of a system for recommending an alternative food item to a user according to one embodiment of the present invention;

FIG. 4 is a flowchart of a method performed by the system of FIG. 3 according to one embodiment of the present invention;

FIG. 5 is a dataflow diagram of a system for aggregating food-related data from a plurality of users and providing advice to the plurality of users based on the aggregated data;

FIG. 6 is a flowchart of a method performed by the system of FIG. 5 according to one embodiment of the present invention; and

FIGS. 7A-7L are illustrations of screenshots of a device executing software implemented according to various embodiments of the present invention.

### DETAILED DESCRIPTION

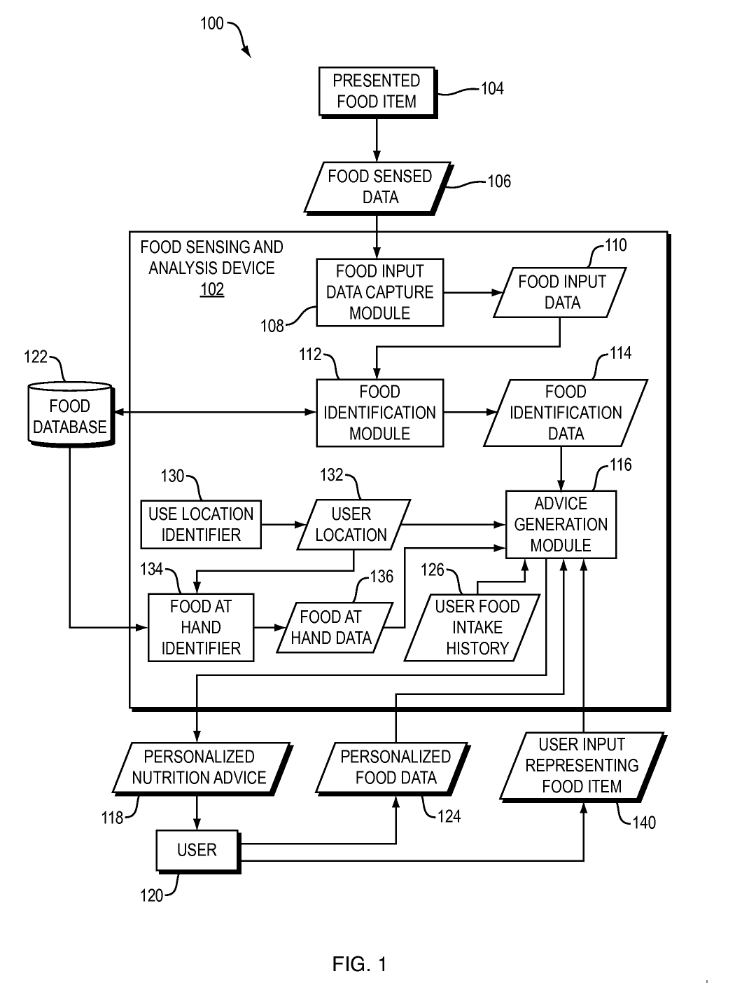

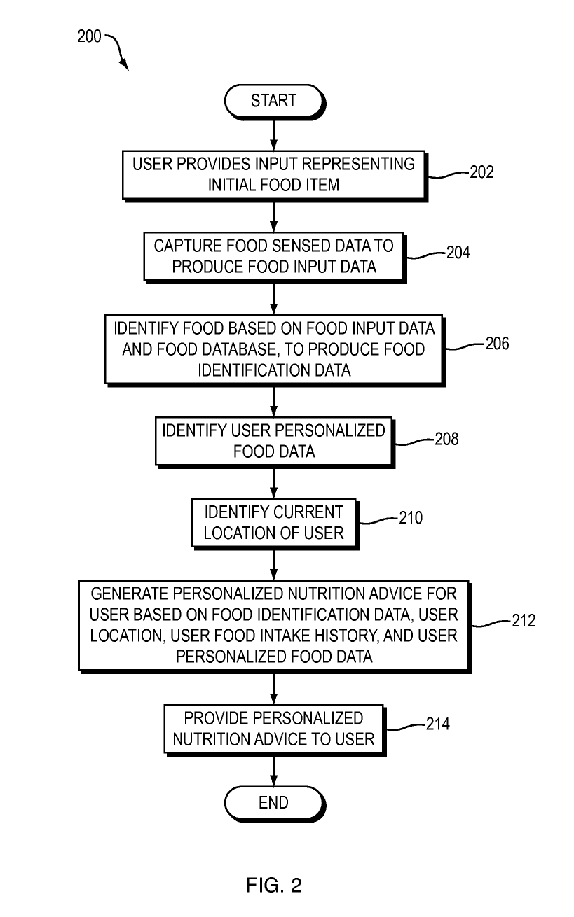

Referring to FIG. 1, a data flow diagram is shown of a system 100 for providing personalized nutrition advice 118 to a user 120. Referring to FIG. 2, a flow chart is shown of a method 200 performed by the system 100 of FIG. 1 according to one embodiment of the present invention.

The system 100 may be implemented, at least in part, using a food sensing and analysis device 102. The device 102 may, for example, be any kind of computing device, such as a laptop computer, personal digital assistant (PDA), cellular telephone, smartphone, or other mobile, portable, or user-implanted, electronic computing device which has been configured to perform the functions disclosed herein, such as by programming it with appropriate software.

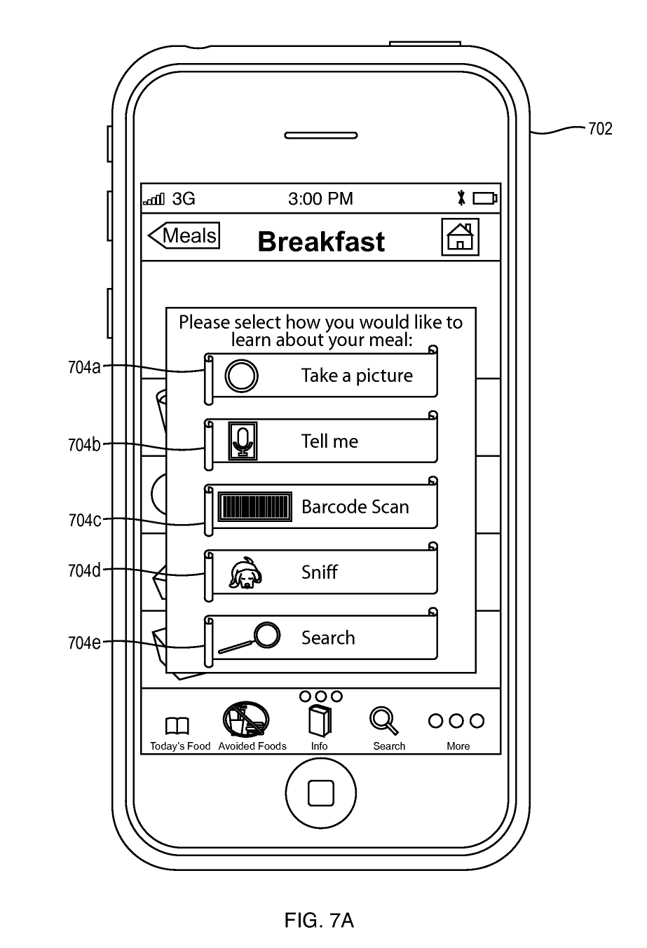

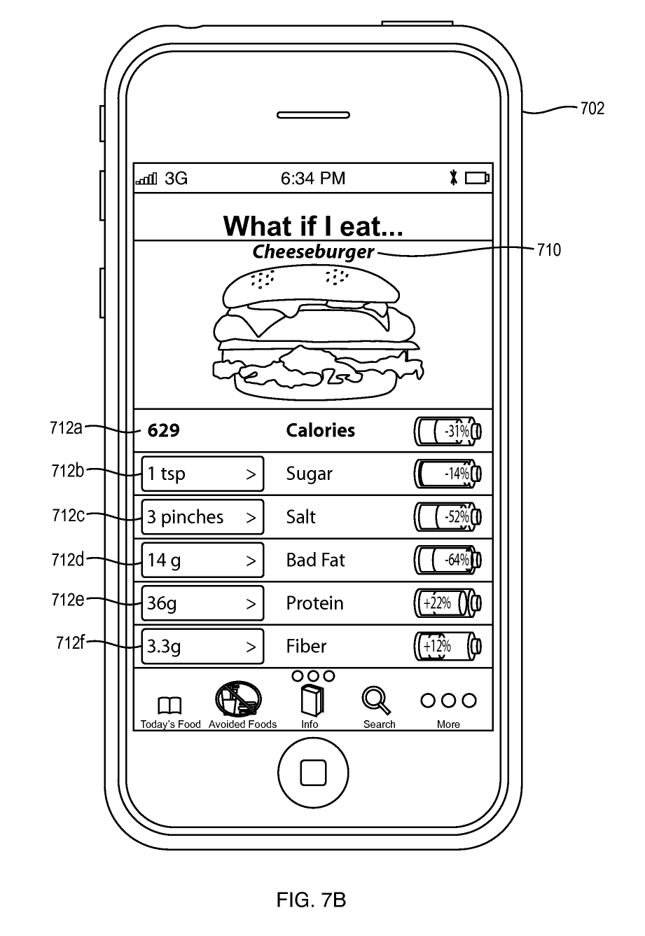

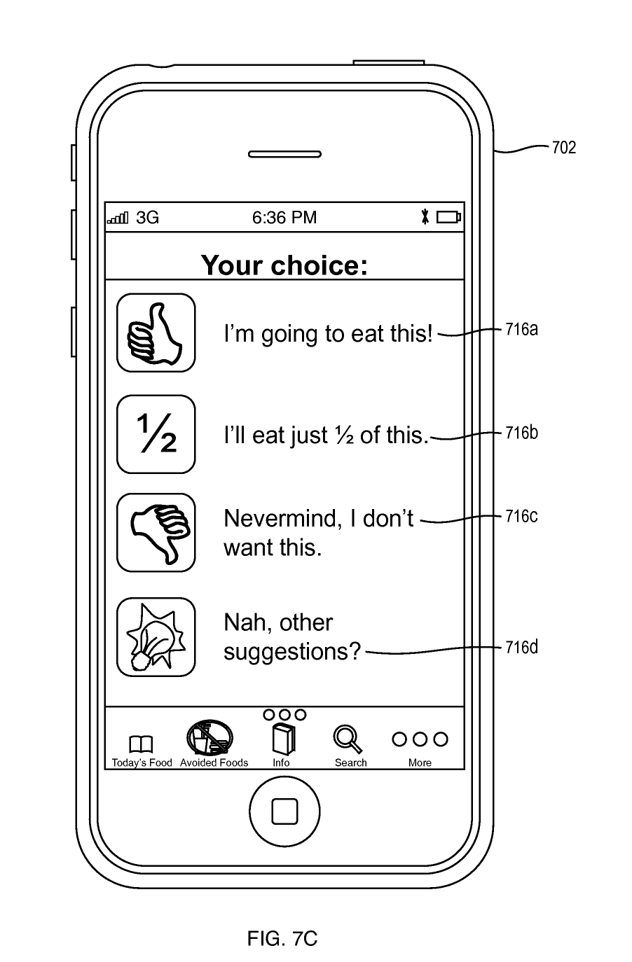

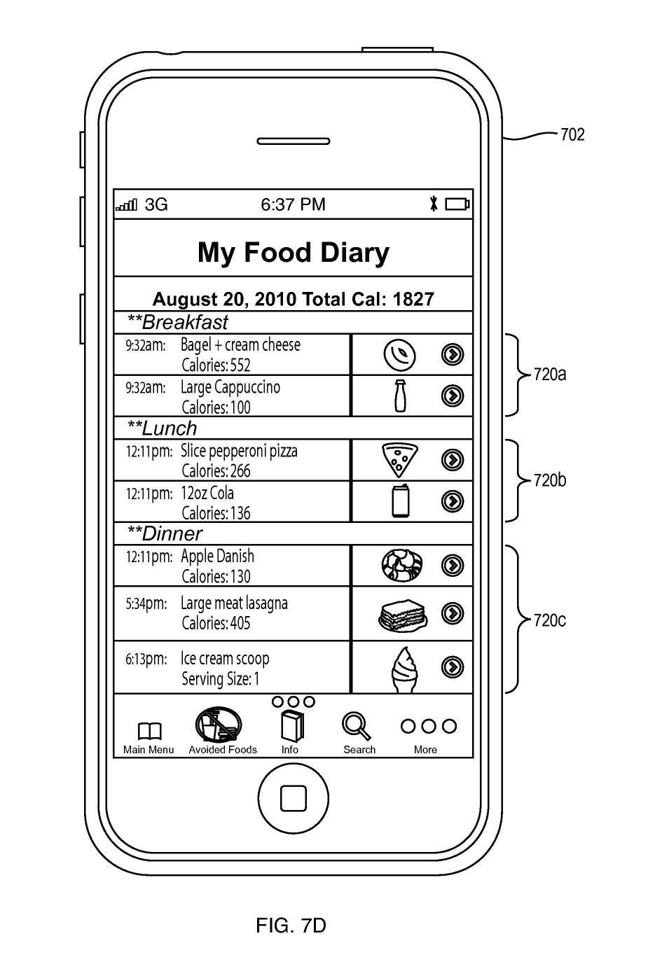

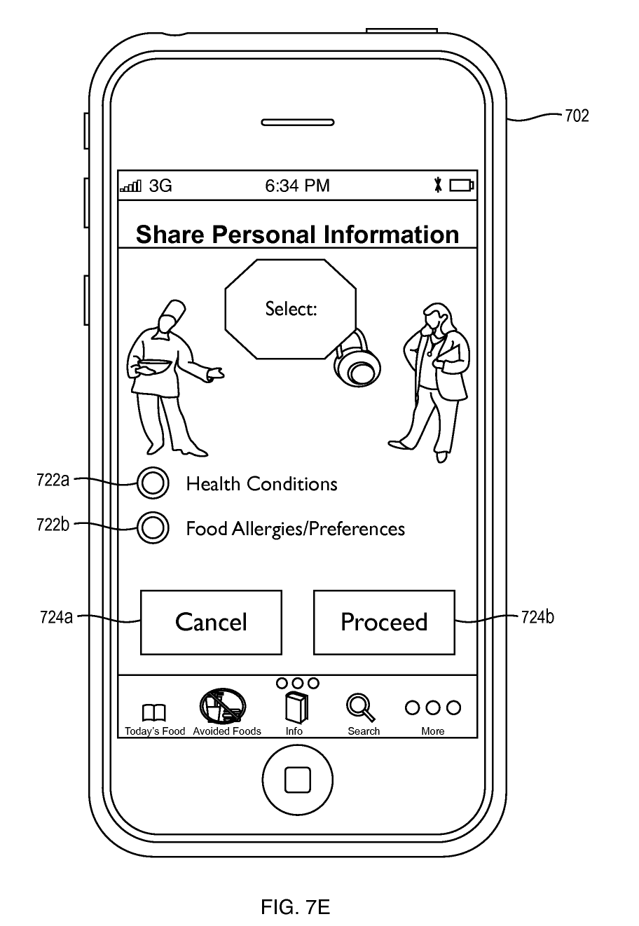

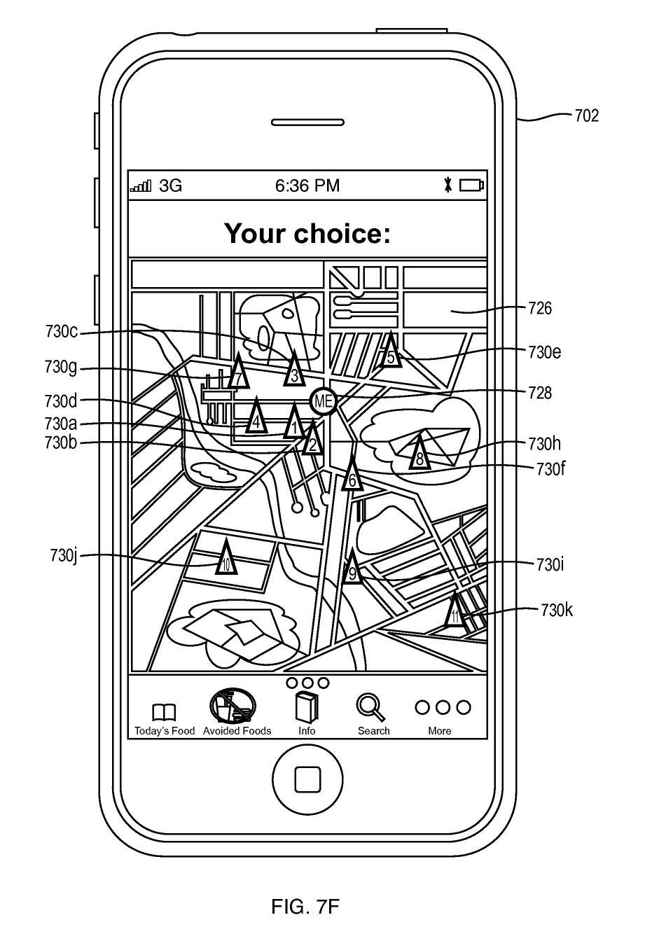

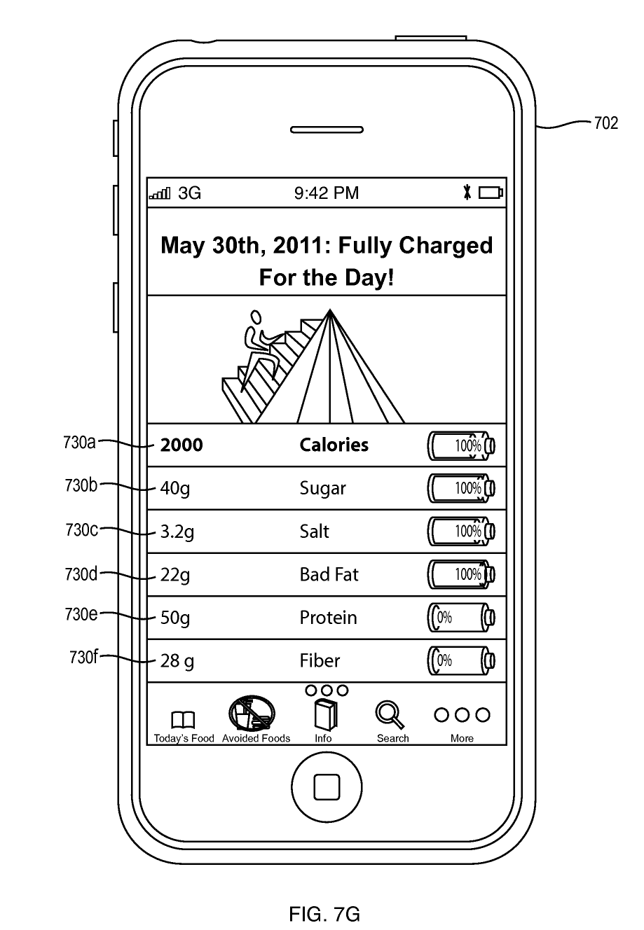

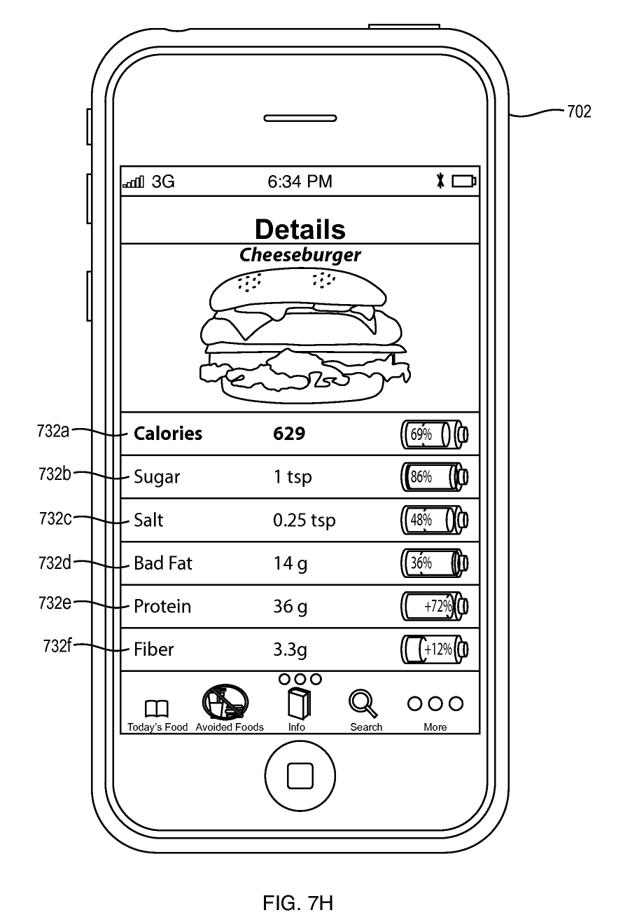

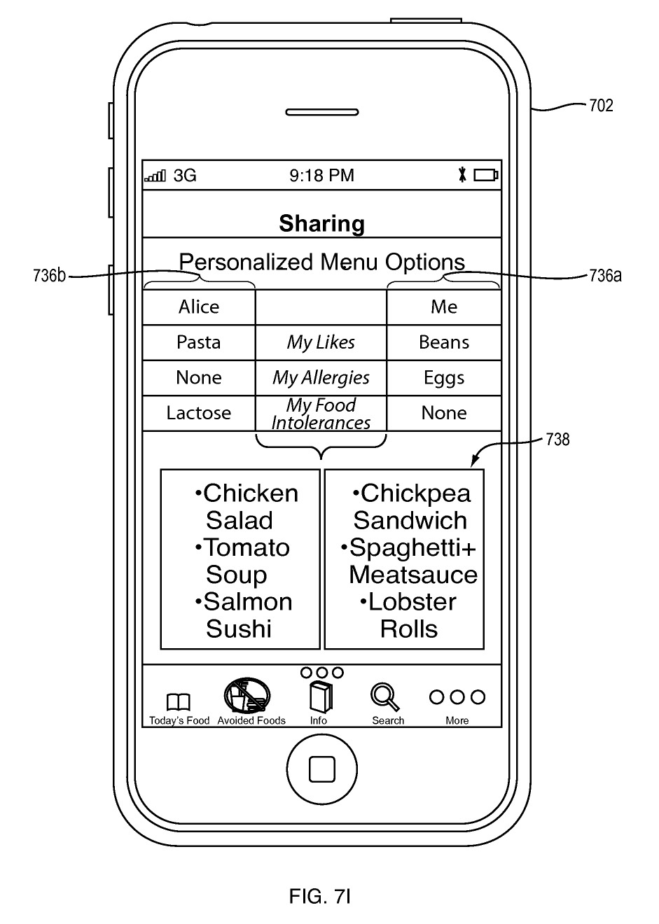

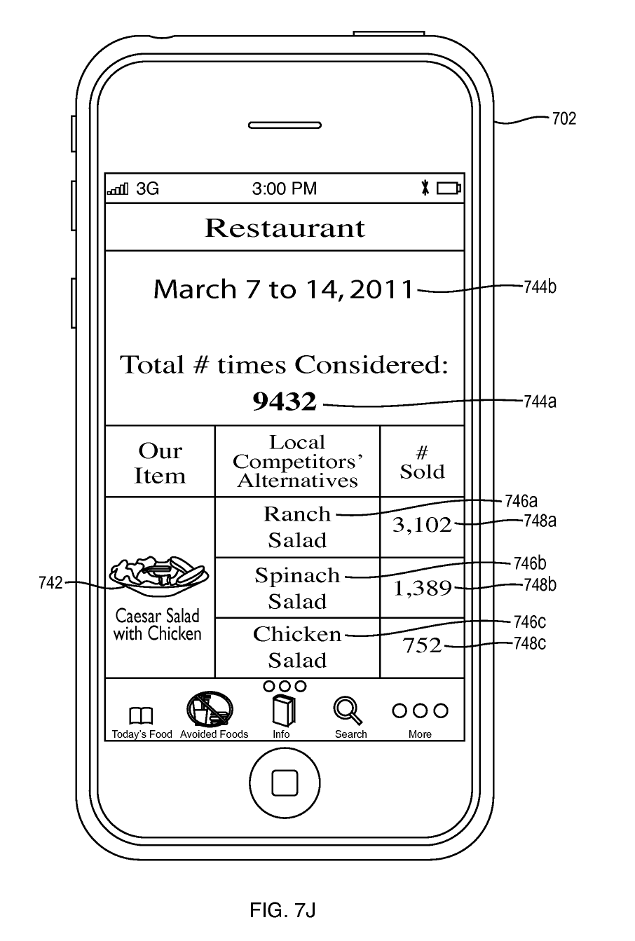

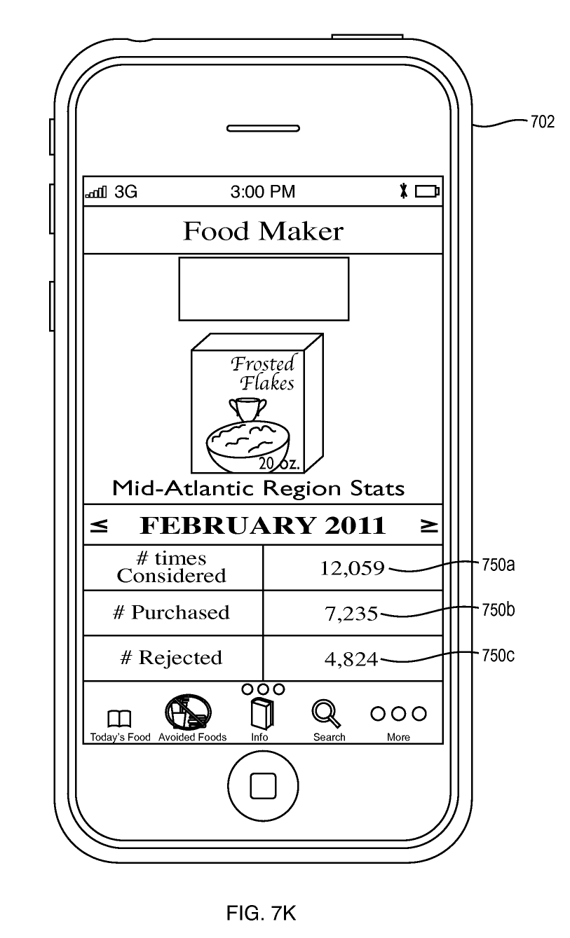

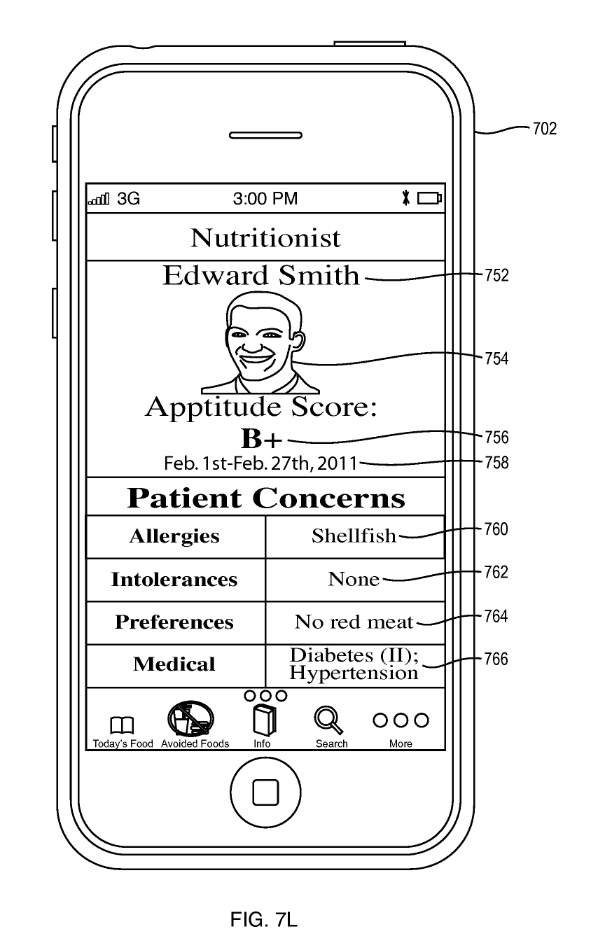

A user 120 presents to the device 102 an initial food item 104 within the vicinity of the device (FIG. 2, step 202). More specifically, the user 120 provides user input 140 representing food item 104. The user 120 may provide the input 140 to the device 102, and thereby present the initial food item 104 to the device 102, in any of a variety of ways. For example, as illustrated in FIG. 7A, device 702 (which may be an implementation of device 102 of FIG. 1) may prompt the user 120 to select a method of providing the input 140 from among a variety of available methods. The user 120 may select a particular method by pressing a corresponding one of the buttons 704a-e.

For example, the user 120 may:
use the device 102 to type or select a name or other description (such as a photograph) of the initial food item 104 (such as by pressing button 704e on device 702 and then typing a name or other description (such as a photograph) which the device 702 may accept as the name or other description of the initial food item 104, or use as a query to search for a name or other description (such as a photograph) of the initial food item 104;
speak a name or other description of the food item 104 into the device 102 (e.g., after pressing button 704b on device 702);
use a camera or other image capture module within the device 102 to capture an image of the food item 104 (e.g., after pressing button 704a on device 702);
use the device 102 to read an RFID tag or code (such as a Universal Product Code (UPC) or European Article Number (EAN)) attached to or otherwise associated with the food item 104 (e.g., after pressing button 704c on device 702);
use the device 102 to “smell” the food item (e.g., after pressing button 704d on device 702).

The input 124 provided by the user 120 may include only partial information about the initial food item 104, such as its name or other description. As another example, the user 120 may simply point the device 102 at the initial food item 104 and instruct the device 102 to sense the initial presented food item 104.

In such circumstances, the device 102 may develop a more complete set of food identification data 114 which describe the initial food item 104 presented to the device 102 by the user 120. In the example illustrated in FIG. 1, the device 102 includes a food input data capture module 108, which captures food sensed data 106 from the food item 104 presented by the user 120 to produce food input data 110 (FIG. 2, step 204). The food input data capture module 108 may capture the food sensed data 106 in any of a variety of ways, such as by reading an RFID tag associated with the presented food item 104, reading a bar code associated with the presented food item 104, or by using, for example, gas chromatography (GC), GC-mass spectrometry (GCMS), mass spectrometry in a non-vacuum environment, Atmospheric Pressure Chemical Ionization (APCI), Micro Electro-Mechanical Systems (MEMS), ion mobility spectroscopy, dielectrophoresis, infrared spectroscopy, near-infrared spectroscopy, chemical and conductometric sensors, electronic nose sensors, synthetic olfaction sensors, solid state sensors, Raman sensors, photo analysis, 3D photo modeling, video analysis, biosensors, bio-mimetic systems, photometric sensors, bar code scanning, reading of Radio Frequency Identification (RFID) tags, micro-cantilevers, nano-cantilevers, and any miniaturized equipment developed to smell gas molecules such as volatile organic compounds and peptides. The device 120 may include any one of more of the above technologies and other miniaturized equipment developed to smell gas molecules such as volatile organic compounds, running in tandem with system-powered databases. All of these methods of capturing the food sensed data 106 are also referred to herein as “sensing” the presented food item 104. The food sensed data 106 includes any matter and/or energy received by the food input data capture module 108 from the sensed food 104 which the food input data capture module 108 may analyze at the macroscopic and/or microscopic level to produce the food input data 110, which may represent the food sensed data 106 in any appropriate manner.

The device 102 may also include a food identification module 112, which analyzes the food input data 110 to produce food identification data 114 which identifies the sensed food 104 (FIG. 2, step 206). The food identification module 112 may also use a food database 122, in conjunction with the food input data 110, to produce the food identification data 114. The food identification data 114 may describe the presented food item 104 in any of a variety of ways, such as by name and/or contents. The contents of the sensed food 104 may be represented using, for example, one or any of the presented food item's ingredients (e.g., “potatoes,” “cottonseed oil,” and “salt”) and nutritional content (measured, for example, in terms of one or more of calories, proteins, fiber, sugar, salt and bad fat (saturated fat and trans fat). Quantitative values may be associated with such ingredients/nutrients, and be measured in any units (e.g., teaspoons or grams).

The food database 122 may also contain real-time user location, body mass index (BMI) history, medical history, risk factors associated with various diseases and medical conditions such as obesity and diabetes, demographic diversity, availability of food resources to the user 120 at various times of the day, and relevant epidemiological parameters.

The module 112 may select the appropriate use and exclusion of different components of the device 102 in sequential steps with cyclical iterations to create the dataset needed for precise identification of the food 104 presented to it. The module 112 aligns distinct entities of data in specific combinations to create a matrix where multivariate modeling and set trigger points determine the depth of analysis required of each technology so that each relevant component is run until the evaluation of a given substance is completed to the level sufficient for its identification as food identification data. For example, if the presented food item 104 could, at the outset, possibly be one of 10,000 different possible foods, then ion mobility spectroscopy may narrow down this range of possibilities to 1,000 different possible foods. Then micro-cantilevers, for example, may be used to further narrow down this range of possibilities to 100 different possible foods. Then synthetic olfaction sensors, for example, may be used to further narrow down this range of possibilities to 10 different possible foods. Finally, nano-cantilevers, for example, may be used to identify, with a high degree of accuracy, the identity of the presented food item 104.

As a particular example of the techniques described above, assume that the presented food item 104 has 600 molecules, of which only 12 are used as markers to identify the category of the presented food item 104. Further assume that 5 of these 12 marker molecules may be analyzed to identify five respective specific kinds of food within the category, along with the identity of nutrients in those specific kinds of food. Furthermore assume that the identification of certain molecules in the presented food item 104 allows the origin of the presented food item 104 to be identified.

To further illustrate this example, assume that the presented food item 104 is a piece of chocolate which has 600 molecules, of which 12 allow the food identification module 112 to determine whether the piece of chocolate is composed of milk or dark chocolate. Further assume that 5 molecules, and their relative concentration, allow the food identification module 112 to identify coca butter in the piece of dark chocolate and to derive the nutrients associated with that piece of chocolate. Further assume that a specific molecule allows the food identification module 112 to determine that the piece of chocolate is made from Venezuelan coca beans.

Then, in one embodiment of the invention, the system 100 would allow using a particular technique, for instance ion mobility or near-infrared spectroscopy, to narrow down the number of potential product categories to chocolate; using another technique, such as nano-cantilevers, to identify any of the 12 molecules used as markers for chocolate; further using, for example, electronic nose sensors or synthetic olfaction sensors, to identify that chocolate to be dark, and possibly to identify the origin of the cocoa beans.

Such multivariate analysis may be performed in parallel or in series, either in isolation or in combined multi-regression analysis that allows iterations while combining the use of various techniques, hence accelerating the process of identifying the food sample with accuracy.

The presented food item 104 may include one or more items of food. As a result, the food input data 110 may include data representing each such item of food, and the food identification data 114 may include data identifying each such item of food. For example, referring to FIG. 7B, an example of device 702 is shown in which the presented food item 104 is a cheeseburger, and in which the device 702 displays a variety of information about the presented food item 104 to the user 120. For example, the food input data 110 may represent sensed characteristics of the cheeseburger, and the food identification data 114 may identify the cheeseburger by name (displayed as “cheeseburger” 710); and/or by its ingredients (e.g. ¼ pound of processed beef, 10 g of cheddar cheese, 4 leaves of lettuce, 1 slice of tomato, 6 g of pickles, 8 g of red onion, 1 bun, 2 g of sesame seeds); and/or by its nutritional contents (e.g., 629 calories (element 712a), 1 tsp sugar (element 712b), 3 pinches salt (element 712c), 14 g bad fat (element 712d), 36 g protein (element 712e), and 3.3 g fiber (element 712f)). If, instead, the sensed food 104 includes both a hamburger and French fries, then the food input data 110 may separately represent the hamburger and the French fries, and the food identification data 114 may separately identify each of the hamburger and the French fries. Alternatively, for example, the food identification data 114 may identify the combination of hamburger and French fries as a single item of food using, for example, a single name (e.g., “hamburger and French fries”) and a single set of combined contents, ingredients, calories, and nutrients.

Although in the examples described above the device 102 senses the presented food item 104, this is not a requirement of the present invention. The device 102 may develop the food identification data 114 describing the presented food item 104 without sensing the presented food item 104. For example, the user 120 may input a name or other description of the presented food item 104 to the device 102 as the user input 140 representing food item 104, in response to which the device 102 may develop or otherwise obtain food identification data 114 for the presented food item 104 based solely on data contained in the food database 122.

The system 100 may develop personalized nutrition advice 118 for the user 120 including, for example, a recommendation that the user 120 should or should not eat the presented food item 104. Before describing ways in which the system 100 may make such recommendations, consider that the user 120 may provide, or the system 100 may otherwise obtain, personalized food data 124 associated with the user 120 (FIG. 2, step 208). The personalized food data 124 may include any data associated with the user 120 which describes characteristics of the user 120 that are relevant to the user's food choices and/or nutritional needs. For example, the personalized food data 124 may include foods that the user 120 prefers to eat or chooses not to eat (e.g., meat or green beans); food allergies of the user 120; food intolerances of the user 120; medical conditions of the user 120 (e.g., diabetes or high blood pressure); and the minimum and/or maximum amount of calories, proteins, sugar, salt, and/or bad fat (or other contents/ingredients) which the user 120 prefers to consume in a day or other period of time.

The user 120 may provide the personalized food data 124 to the system 100 in any way, such as by dictating the personalized food data 124 using speech, or by entering the personalized food data 124 using a keyboard or other manual input device, or by filming or photographing presented food item 104. Alternatively or additionally, the system 100 may add to or edit the personalized food data 124 by observing the user's selections of food to eat and/or not to eat over time.

The device 102 may also include a user location identifier module 130, which identifies the current location 132 of the user 120 (FIG. 2, step 210). The module 130 may identify the user's current location 132 (i.e., the user's location at a particular time or range of times) in any of a variety of ways, such as by using global positioning system (GPS) technology, or by receiving manual or voice input (e.g., a postal code or street address) from the user 120 specifying the user's current location. The device 102 may repeatedly update the user's current location 132 over time as it changes. The location 132 may be represented in any way, such as by using longitude and latitude, street address, or by information identifying the restaurant, grocery store, or other establishment at which the user 120 is dining/shopping.

Alternatively, for example, the user location 132 may not be a current location of the user 120. Instead, for example, the user location 132 may be a location specified manually by the user 120, such as a zip code or address typed by the user 120 into the device 102 or a geographical space identified be the user 120 into the device 102 via a map. The location 132, therefore, need not correspond to a current or past location of the user 120, but may be any location, such as a location selected arbitrarily by the user 120, or a location which the user 120 plans to visit later the same day. Any of the techniques disclosed in connection with the user location 132 may be applied to the user location 132 whether or not the user location 132 represents a current location of the user 120.

Although not shown in FIG. 1, the device 102 may also identify the current time, such as by using an internal clock or accessing an external clock over the Internet or other network. The device 102 may associate the current time with the user's current location 132 (i.e., the time at which the user 120 is located at the current location 132) and store a record of the current time in association with any records that the device 120 stores of the user's current location 132. For example, the device 102 may store a record of the time at which the user 120 presented food item 104 for each and every occurrence. Therefore, any description herein of ways in which the current location 132 may be used should be understood also to apply to uses of the current time associated with the current location 132. As this implies, at the time that a particular current location or current time is analyzed by the system 100, such values may no longer be “current.” For example, as described in more detail below, the system 100 may analyze the user's food intake history 126, which may include a historic record of one or more previous current locations and associated current times of the user 120, at which point such locations and times represent past locations and times.

The system 100 may include an advice generation module 116, which generates personalized nutrition advice 118 tailored to the user 120, based on any one or more of the food identification data 114, the user location 132 (which may include the current time), the user food intake history 126, and the personalized food data 124 (FIG. 2, step 212). In general, the advice 118 represents a recommendation that the user 120 eat, or not eat, food specified by the advice 118 (such as the presented food item 104) at the current time. The device 102 may present the personalized nutrition advice 118 to the user 120 (FIG. 2, step 214).

Although the advice 118 is personalized to the user 120, the advice 118 may be based at least in part on generic information that is not personalized to the user 120. For example, in one embodiment of the invention, the advice generation module 116 may base the advice 118 at least in part on the knowledge base and dietary guidelines of the healthy eating pyramid (MyPyramid) developed by the United States Department of Agriculture (U.S.D.A.) and/or incorporate advice disseminated by the Centers for Disease Control and Prevention (C.D.C.), the US Food and Drug Administration (F.D.A.), or the World Health Organization (W.H.O.), or any other international organization or governmental body, as it relates to food safety programs, product-specific information, food allergens, food borne illness, and food contaminants.

For example, the system 100 may conclude that the user 120 should not eat the presented food item 104 and then advise the user 120 accordingly. Such a conclusion may, for example, be drawn based on the food identification data 114 and the user's personalized food data 124, by determining that the sensed food 104 contains one or more items to which the user 120 is allergic. The recommendation 118 provided to the user 120 may include, for example, a statement indicating that the user 120 should not eat the sensed food 104 (e.g., “Do NOT eat this”) and, optionally, an explanation of the reason for the recommendation (e.g., “Do NOT eat this, it contains shellfish”).

Similarly, as another example, the system 100 may conclude that the user 120 may eat the sensed food 104, and then advise the user 104 accordingly. Such a conclusion may, for example, be drawn based on the food identification data 114 and the user's personalized food data 124, by determining that the sensed food 104 does not contain any item to which the user 120 is either allergic or intolerant or dislikes, or at least that the system 100 did not identify any contents or ingredient or nutrient to which the user 120 is either allergic or intolerant or dislikes. The recommendation provided to the user 120 may include, for example, a statement indicating that the user 120 may eat the sensed food 104 (e.g., “You may eat this food” or “Go ahead, Bon appétit”) and, optionally, an explanation of the reason for the recommendation (e.g., “Go ahead, Bon appétit; this food does not contain salt and is very healthy for you”).

The advice 118 may be presented to the user 120 in other ways. For example, the system 100 may provide the personalized nutrition advice 118 to the user 120 using any one or more of the following: (i) a green/red/or orange flashing light; (ii) a text message; and (iii) a voice message that the user 120 can personalize, choosing from a library of voices that is self-created, provided by the system 100, or pre-existing. Examples might include the voice of famous actresses or actors, singers, athletes, etc. (“Bon appétit”—green light); or of a cartoon character recognized by children of various ages (“Do not eat this”—red light); or a computer generated robotic voice (“You've had a little too many sweetened drinks lately, why don't you try vitamin flavored water instead?”—orange flashing light). To expand and further personalize the library, the system 100 may allow the user 120 to record her own voice, that of a friend, or that of her mother or her grandma or her son (to say, for example: “This is good for you!”)

In situations where allergens or toxic agents are identified and the food 104 is contra-indicated for the user 120, in one embodiment of the invention, the food sensing and analysis device 102 signals a “Red Alert” that can be for instance in the form of a red lamp, a siren, a vibration of the device, an alarm, a preset ring tone, a song, a flashing icon on a screen, a warning sign in text form or any other mode that the user's device is capable of. The user 120 may then choose amongst several courses of action from a decision panel including for example the following: (i) Eating the food in spite of the warning, (ii) Eating half of the desired food, (iii) Skipping the snack/meal entirely, or (iv) Asking the system for another recommended option.

In one embodiment of the invention, the personalized nutrition advice 118 is organized in three categories: (1) The total number of calories in the scanned package or the fresh food identified, with, for example, a simple nutrient guide: amount of fiber, proteins, sugar, salt, and bad fat (saturated fat and trans fat) expressed, at the option of the user 120, in grams or equivalent teaspoons or tablespoons and a total daily count indicator for each nutrient represented, for example, by a battery losing its charge as the user's daily allotment is consumed; (2) A total diet quality score for the day, week, month, etc., based on the user's adherence to the recommended system nutrition advice; (3) A rank-ordered list of suggestions for healthy meal preparations and choices at home or at other venues such as cafeterias or restaurants nearby, based on the user's location 132, existing menus at the restaurants in the vicinity of user location 132, food and drinks available in vending machines in the vicinity of user location 132, and food presence at the local markets and food stores nearby, all assessed by the user location identifier 130.

As indicated in the examples above, the system 100 may draw binary (yes/no) conclusions about whether or not the user 120 may/should eat the sensed food 104. Additionally or alternatively, the system 100 may draw conclusions associated with varying degrees of confidence. Such degrees of confidence may have any range of values, such as 0-100%; or “yes,” “no,” and “maybe.” In such embodiments, the recommendation 118 provided to the user 120 may include a statement indicating the degree of confidence associated with the recommendation 118 (e.g., “Not sure about your eating this, you've had a little too much sodium lately”).

The advice generation module 116 may develop the personalized nutrition advice 118 with respect to the presented food item 104 by, for example, using the personalized food data 124 as a query against the presented food item 104, and generating a search result based on the degree to which characteristics of the presented food item 104 match the criteria specified by the personalized food data 124. For example, if the personalized food data 124 indicate that the user 120 is allergic to peanuts, then the advice generation module 116 may form the query, “food category=food type< >peanuts.” Any suitable search technology may be used to process such a search and to develop binary (eat/do not eat) advice or advice taking another form, such as a match score or a range of scores. Other data, such as the user food intake history 126 and the user location 132 may be used to formulate such a search.

The system 100 may advise the user 120 not to eat a particular food item as a result of determining that the particular food item scores poorly (e.g., below a particular threshold level, such as 50%) as the result of performing such a search, or advise the user to eat a particular food item as a result of determining that the particular food item scores well as the result of performing such a search. Alternatively, for example, the system 100 may present the user 120 with a ranked list of food items, ordered in decreasing order of desirability for the user to eat, possibly along with scores associated with each food item.

The personalized food data 124 may indicate positive or negative preferences for particular food items in any of a variety of ways. For example, if the user 120 is allergic to a particular food item, the user's personalized food data 124 may indicate that such a food item is to be absolutely excluded from the user's diet. As a result, the advice generation module 116 may always advise the user 120 not to eat such a food item. In contrast, if the user's personalized food data 124 indicates that the user 120 has a weak preference not to eat a particular food item, then the advice generation module 116 may give such a food item a low weight, and either advise the user 120 to eat the food item or not eat the food item, depending on the circumstances. In addition to food items being listed as allergies or contraindicated to the user's medical conditions, the user 120 may also edit lists of food items within the personalized food data 124, such as a list of favorites, excluded, preferred, and non-preferred foods. The user 120 may assign rankings to food items relative to each other within such lists, and the advice generation module 116 may take such lists, and the rankings within them, into account when generating the personalized nutrition advice 118 and alternative advice 142.

The user 120 may provide additional ranking preferences within the personalized food data 124. For example, the user 120 may rank food items by price, distance from the device 102, type of food, or impact of the food on battery level. The advice generation module 116 may take such ranking preferences into account when generating the personalized nutrition advice 118 and alternative advice 142.

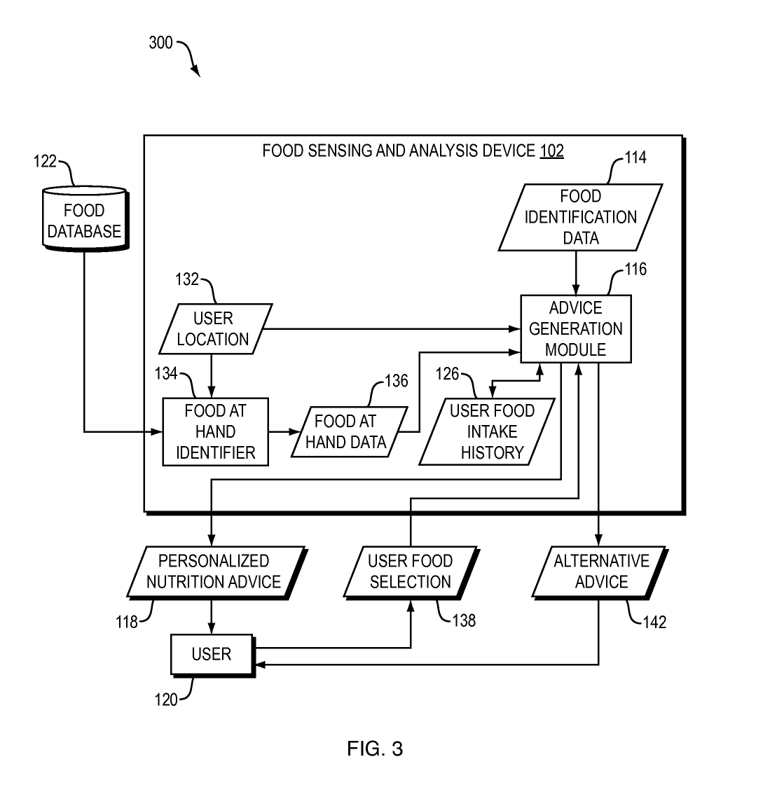

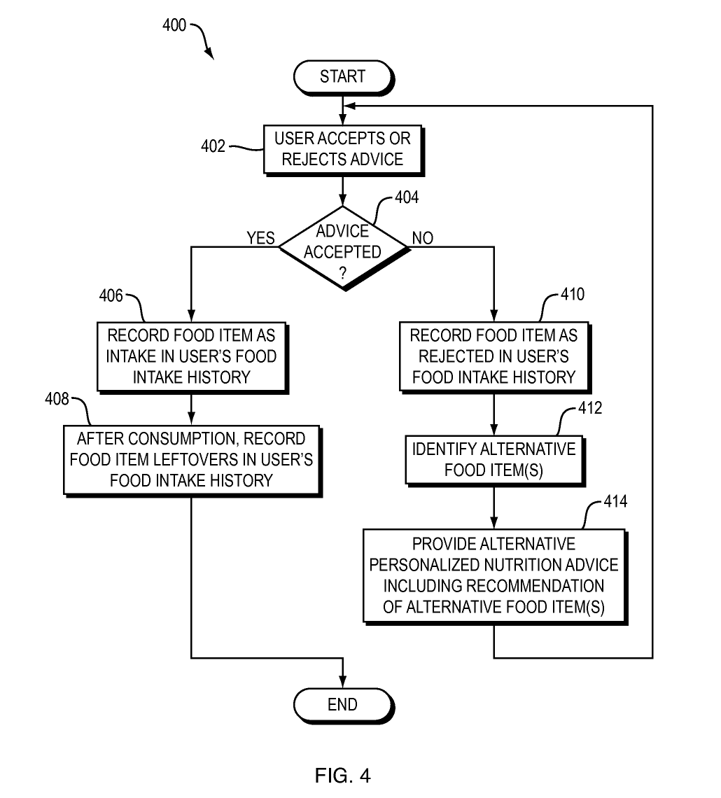

As another example, the system 100 may recommend that the user 120 eat food other than the presented food item 104, as illustrated by the system 300 shown in the dataflow diagram of FIG. 3 and the method 400 shown in the flowchart of FIG. 4. Although the device 102 shown in FIG. 3 may be the same as the device 102 shown in FIG. 1, certain elements from FIG. 1 are omitted from FIG. 3 for ease of illustration.

The system 100 may recommend one or more alternative food items for the user 120 to eat in response to the user's rejection of the initial personalized nutrition advice 118. For example, as shown in FIGS. 3 and 4, the user 120 may provide input such as user food selection 138 indicating the user's selection of food to eat (FIG. 4, step 402). The user 120 may provide such input 138 using any input modality, such as a voice command or keyboard entry (as is true of the personalized food data 124 and any other input provided by the user 120 to the system 100).

For example, in the embodiment illustrated in FIG. 7C, the device 702 prompts the user 120 with options that the user 120 may select in response to the initial personalized nutrition advice 118, such as an “I'm going to eat this!” button 716a, an “I'll eat just of this” button 716b, a “Nevermind, I don't want this” button 716c, and a “Nah, other suggestions” button 716d. The user 120 may provide the user food selection 138 (FIG. 3) by pressing an appropriate one of the buttons 716a-d. In this example, the user's selection of button 716a indicates that the user 120 accepts the initial personalized nutrition advice 118, the user's selection of buttons 716c or 716d indicate that the user 120 rejects the initial personalized nutrition advice 118, and the user's selection of button 716b indicates that the user 120 partially accepts and partially rejects the initial personalized nutrition advice 118.

If the user 120 accepts the initial personalized nutrition advice 118, or otherwise indicates which food item(s) the user 120 intends to eat at the current time (FIG. 4, step 404), then the device 102 stores, in the user's food intake history 126, a record indicating one or more of the following: (1) the user's acceptance of the initial personalized nutrition advice 118; (2) information about the food item(s) to be eaten by the user 120 at the current time; and (3) an indication that the user 120 intends to eat, or has eaten, the food item(s) in (2) at the current time (FIG. 4, step 406). The information stored in the food intake history 126 may include, for example, the food identification data 114 associated with the food to be eaten by the user, the time at which the user 120 responded to the personalized nutrition advice 118, the user location 132 of the user 120 at the time of the personalized nutrition advice 118 and/or the user food selection 138, and the number of other users with similar devices the user 120 was eating with or in proximity to, and whether or not those other users were eating similar food items to presented food item 104 of user 120.

The system 100 may display the user's food intake history 126 to the user 120 in any of a variety of ways. For example, in the embodiment illustrated in FIG. 7D, the device 702 displays data from the current day of the user's food intake history 126 in the form of a personal food diary listing the foods that the user 120 ate for breakfast (in area 720a), lunch (in area 720b), and dinner (in area 720c). Although in the example of FIG. 7E the personal food diary displays the names, number of calories, and images of the foods eaten, the diary may display other data from the food intake history 126 in addition to or instead of such data. Although the diary may show food intake data for the current day by default, the user 120 may search backward in time to display food intake data for previous days, individually or in aggregate.

Once the user 120 has finished eating a meal, the user food intake history 126 may be updated to include a record of the leftover food, if any, from the finished meal (FIG. 4, step 408). The user 120 may, for example, provide input to the device 102 describing the leftover food, such as by typing such a description, or by taking a photograph of the leftover food on the user's plate, or using a food item from the user's food intake history 126 and indicating the proportions left over (e.g. ⅓ or ¼). In one embodiment of the invention, the device 102 may sense the leftover food using any of the technologies disclosed herein, and then record the leftover food within the user food intake history 126. Any of the kinds of information that may be stored for the presented food item 104 itself in the user food intake history 126 may similarly be stored for the leftover food in the user food intake history 126.

Although in certain examples provided herein, the user 120 may choose whether to accept or reject the personalized nutrition advice 118, in other embodiments the system 100 may apply the personalized nutrition advice 118 automatically, i.e., without requiring acceptance from the user 120. For example, the personalized nutrition advice 118 may include a recommendation that a diabetic user be provided with a particular amount of insulin at a particular time, based on the user's personalized food data 124 and input received from a glucose monitoring device which continuously monitors the user's glucose level. In such a case, the device 102 may be connected to an insulin pump attached to the user 120, and the device 102 may output a signal to the insulin pump which instructs and causes the insulin pump to provide the recommended amount of insulin directly to the user 120 at the recommended time. More generally, the system 100 may communicate with other devices to obtain input from such devices about the current state of the user 120, and provide output to other devices to automatically apply the personalized nutrition advice 118 to the user (such as by providing food to the user 120), consistent with the user's personalized food data 124.

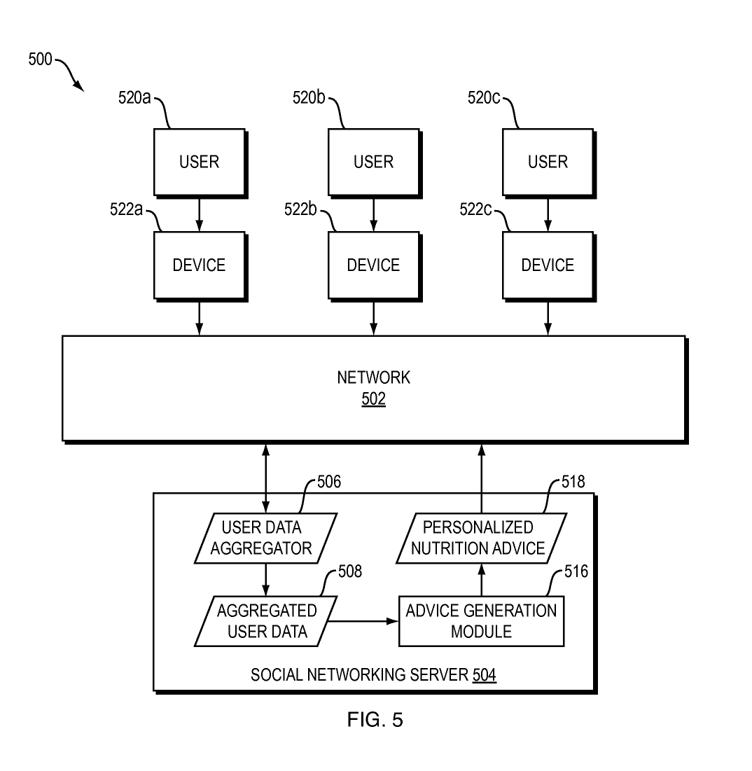

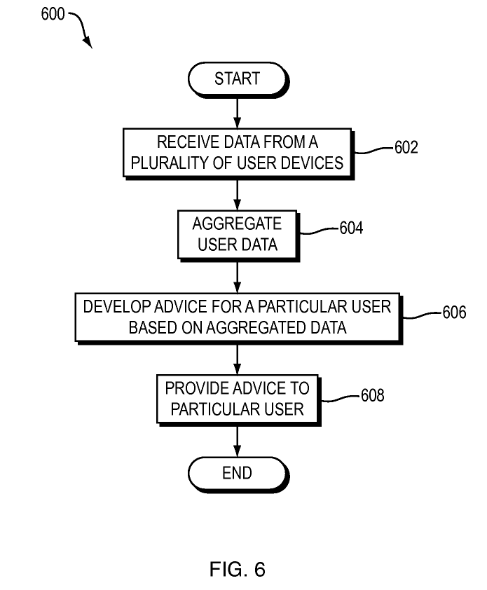

The system 100 may also update the food database 122 with the food identification data 114 developed by the device 102. The device 102 may also transmit other information, such as any one or more of the user location 132, the food at hand data 136, the current time, and the user food selection 138 to the food database 122 for storage in conjunction with the food identification data 114. The user's device 102 may contribute to the food database 122 over time. As will be described in more detail below in connection with FIGS. 5 and 6, such data may then be used to the benefit of both the user 120 and other users of similar devices.

The device 102 may also upload the user personalized food data 124 to the food database 122 and/or other database. However, due to the personal nature of the personalized food data 124, the system 100 may provide the user 120 with control over whether the personalized food data 124 shall be uploaded or not; which portions of the personalized food data 124 shall be uploaded; the uses to which any uploaded portions of the personalized food data 124 may be put; and which other users shall have individual restricted permission to access the personalized food data 124 of user 120. The user 120 may, for example, use a user interface such as that shown on the device 702 in FIG. 7E, to indicate which personalized food data 124 of the user 120, if any, is allowed to be uploaded and/or shared with other user. In the embodiment of FIG. 7E, the user 120 may select button 722a to indicate that the user 120 grants permission to share health conditions of the user 120 with other users (or leave button 722a unselected to keep such information private). Similarly, the user 120 may select button 722b to indicate that the user 120 grants permission to share food allergies and preferences with other users (or leave button 722b unselected to keep such information private). The user 120 may then select button 724b to cause the user's selections to take effect, or select button 724a to cancel (in which case the user's health conditions and food allergies/preferences will remain private).

If the user 120 rejects the initial personalized nutrition advice 118, or otherwise indicates that she or he would like to be presented with additional food options, the system 300 may store, in the user's food intake history 126, a record indicating that the user 120 rejected the initial personalized nutrition advice 118 (FIG. 4, step 410), identify one or more alternative food items to recommend to the user 120 (FIG. 4, step 412), and then develop and provide to the user 120 alternative advice 142 based on the alternative food item(s) (FIG. 4, step 414). Although the alternative advice 142 may include advice to eat the alternative food items, it may additionally or alternatively include advice not to eat the alternative food items. For example, if the user 120 rejected the initial personalized nutrition advice 118 and provided the system 100 with a list of one or more alternative food items that the user 120 would prefer to eat, the system 100 may advise the user 120 not to eat one or more of those alternative food items.

The alternative food item(s) may be identified in step 412 any of a variety of ways, based on one or more of the user's personalized food data 124, the user's food intake history 126, the user's location 132 and current time, and the food database 122. In particular, the system 100 may evaluate potential alternative food items for suitability for the user 120 using any of the techniques described above with respect to evaluation of the initial presented food item 104.

Furthermore, the system 100 may identify food currently within the vicinity of the device 102 (whether or not such food has been presented by the user 120 to the device 102) and only select alternative food item(s) from within the identified food currently within the vicinity of the device 102. To this end, the system 100 may also include a “food at hand” identifier 134 that identifies food within the vicinity of the user 120. The food at hand identifier 134 may identify the food at hand, thereby producing food at hand data 136 representing the food at hand, in any of a variety of ways. For example, the food at hand identifier 134 may use the user location 132 and the geo-referenced food database 122 to identify food within the user's vicinity. The food database 122 may, for example, include records identifying both the contents of a plurality of items of food and the current geographic location of each such item of food. The food at hand identifier 134 may cross-reference the user's current location 132 against the geographic locations of the items of food in the food database 122 to identify one or more items of food which currently are in the vicinity of the user 120.

The food at hand may be identified in any of a variety of preparations, for example it may encompass fresh food, cooked or raw, served hot, warm, or cold, or at room temperature, served via such a container or vessel as a plate, a bowl, a glass, or a cup. The system 100 may also identify the food at hand that is for instance, packaged, boxed, bottled, or canned, etc.

The food at hand identifier 134 may define the current “vicinity” as, for example, a circle, square, rectangle, or other shape centered on (or otherwise containing) the user's current location 132 and having a size (e.g., diameter, length, width, volume, or area) defined by input from the user 120 or in other ways (e.g., the distance the user 120 can travel using the user's current or projected mode of transportation or traveling at the user's current rate of speed within a particular amount of time). Conversely, the food at hand identifier 134 may define current “vicinity” by the time it would take the user 120 to reach the location where alternate food items may be available, at the user's current or projected mode of transportation. The system 100 may prompt the user 120 to chose the modalities defining current “vicinity” of user 120 in any of the above systems, for example based on the time of travel as opposed to distance: “What alternate food items are available to the user 120 within 4 minutes of the user 120?” As another example, the “vicinity” of the user 120 may be defined as the city, street, food court, restaurant, building, or other food sale establishment in which the user 120 currently is located or in which the user 120 projects to be.

As another example, the food at hand identifier 134 may identify the food at hand by reading RFID tags associated with food items within the vicinity of the device 102, smelling food items within the vicinity of the device 102, or reading bar codes or other codes within the vicinity of the device 102. More generally, the food at hand identifier 134 may use any one or more of the technologies described above in connection with the food input data capture module 108 to identify food in the vicinity of the device 102.

The food at hand data 136 and/or the food identification data 114 may indicate the origin of the corresponding food, where “origin” may include, for example, the geographic location (e.g., town, city, state, province, country, or coordinates) in which the food was grown, aged, manufactured, prepared, or packaged. The origin of the food contained in the food database 122, the food identification data 114, or the food at hand data 136 may additionally include (i) the identification of the farm, land, waters, or factory where the food was grown, made, raised, bottled, or processed; (ii) the identification of the owners of such farm, land, plant, factory, etc. whether such owners are individuals or corporate entities; and (iii) what type of other foods are grown or made or processed in such facilities (e.g., the origin of presented food item 104 included in food database 122 may be a plant that also processed food containing peanuts). The origin of the food may be used in the same manner as any other characteristic of the food identification data 114 and food at hand data 136 in the processes described herein.

As mentioned above, each food item may be associated with a location. Such a location may be represented in any way, such as by latitudinal/longitudinal coordinates, elevation, or an indication of the vending machine, food court, restaurant, building, or exact location within the building, or other food sale establishment at which the food item is located. Similarly, the location of a food item may indicate where within a particular home (e.g., refrigerator, cupboard, pantry closet, freezer) the food item is located, or where within a particular food establishment (e.g., floor, department, aisle) the food item is located.

The device 102 may combine the food identification data 114 (representing the presented food item 104) and the food at hand data 136 to produce a combined data set representing the total set of food at hand included in the food database 122. Therefore, any reference herein to processes which may be applied to the “food at hand” should be understood to apply to the food identification data 114, the food at hand data 136, or a combination of both or any subset of the food database 122 that is considered in the “vicinity” of the user 120 as described above.

In particular, note the case in which there is no food identification data 114, such as because the device does not include the food input data capture module 108 and/or food identification module 112, or because for some reason the device 102 is unable to produce the food identification data 114 successfully. In this case, the device 102 may perform the functions disclosed herein solely on the food at hand data 136, representing food other than the presented food item 104 as presented to the device 102 by the user 120.

As the description above illustrates, the system 100 may identify non-sensed food at hand in response to the user's rejection of the initial personalized nutrition advice 118. In another embodiment, the system 100 may identify non-sensed food at hand without first waiting for the user 120 to reject any advice. For example, the advice generation module 116 may identify the alternative food items (step 412) and provide the alternative advice 142 spontaneously in response to sensing the presented food item 104 or in response to detecting the presence of food at hand 136 within the vicinity of the user 120, in response to a potential purchase of food by the user 120, or in response to a specific request from the user 120 to provide advice related to food within the vicinity of the device 102.

The alternative advice 142 may take any of a variety of forms, such as the statement, “You should really eat more whole grains and less refined starch, why don't you order the sandwich on whole wheat bread and skip the French fries?” Such a recommendation may suggest healthy, achievable goals, drawn from the food at hand 136 (e.g., the food within the vicinity of the user's location 132 at a particular time) to motivate the user 120 and in some instances, gradually begin to positively influence the eating behavior of the user 120.

As another example, and as illustrated in FIG. 7F, the alternative advice 142 may take the form of a map 726 which illustrates the location(s) of the food at hand represented by the food at hand data 136. In particular, in the example of FIG. 7F, the map 726 includes an icon 728 representing the user location 132, and a plurality of icons 730a-k representing locations of food at hand. Although in the example of FIG. 7F, the icons 730a-k are numbered in order of increasing distance from the user location 132, such icons 730a-k may be numbered in other ways, such as in order of decreasing match to the user's personalized food data 124 or, for instance, in order of increasing price.

As illustrated in FIG. 4, it is possible that the user may reject the alternative advice 142. In this case, the system 100 may develop and provide to the user 120 additional alternative food advice (not shown) using any of the techniques described herein. Furthermore, if the initial alternative advice 142 was developed to include only food chosen from the food at hand 136 that was within a particular distance (e.g., radius) or time of reach (e.g., 4 minutes) of the user's current location 132, the system 100 may identify additional alternative options either by selecting other food from within the same initial distance, or by increasing the distance and again identifying one or more food options within that distance of the user's current location 132. As another example, if the system 100 initially advised the user 120 to eat food selected from the top of a ranked list of food, the system 100 may identify alternative food options from positions lower on the same list. Such a list may, for example, be ranked in order of the degree of match of the items on the list to the user's personalized food data 124 and/or food intake history 126.

The system 100 may also identify additional alternative food options having different (e.g., higher or lower) prices than the alternative food items initially recommended, food options having different (e.g., higher or lower) total diet quality scores (see below) than the alternative food items initially recommended, food which has a more or less desirable effect on the user's personal battery level (see below) than the alternative food items initially recommended, or food having any other characteristics than the alternative food items initially recommended (e.g., a packaged meal instead of a fresh meal, or a take-out meal instead of a sit-down meal).

As described above, the system 100 may specifically advise the user 120 not to eat particular food. For example, the system 100 may advise the user 120 not to eat the presented food item 104 presented by the user 120 to the device 102. As another example, the system 100 may identify a plurality of potential food items to be consumed by the user 120 (such as by allowing the system to read a plurality of RFID tags in the vicinity of the user 120) and then specifically advise the user 120 not to eat one or more particular ones of the plurality of potential food items.

Associated with the user 120 may be one or more periodic nutritional intake parameters, such as proteins, fiber, calories, salt, sugar, and bad fat. Each such parameter may have a corresponding maximum periodic value (e.g., the maximum amount of calories that the user 120 should consume within an hour, day, or week) and a current periodic value (e.g., the number of calories the user 120 has consumed so far within the current day or week as the case may be). The device 102 may store or otherwise have access to the maximum and current values of each parameter within the user's personalized food data 124. The device 102 may (e.g., as part of providing the initial personalized nutrition advice 118 or alternative advice 142) inform the user 120 of the maximum and/or current value of each parameter, such as by displaying a chart of the user's maximum and currently-consumed calories, salt, sugar, and bad fat.

For example, FIG. 7G illustrates an embodiment in which the device 702 displays the current values of the user's periodic nutritional intake parameters at the beginning of a day. As a result, the current values of the periodic nutritional intake parameters in FIG. 7G are equal to zero. Therefore, the battery level associated with each of the periodic nutritional intake parameters which has a recommended maximum daily intake amount (i.e., calories, sugar, salt, and bad fat) is shown as 100% (i.e., 0% discharged) in FIG. 7G, while the battery level associated with each of the periodic nutritional intake parameters which has a recommended minimum (target) daily intake amount (i.e., protein and fiber) is shown as 0% in FIG. 7G. More specifically, in FIG. 7G:
area 730a shows that the user's maximum recommended number of calories per day is 2000 and that the user 120 has not yet consumed any calories;
area 730b shows that the user's maximum recommended amount of sugar per day is 40 g and that the user 120 has not yet consumed any sugar;
area 730c shows that the user's maximum recommended amount of salt per day is 6.4 pinches and that the user 120 has not yet consumed any salt;
area 730d shows that the user's maximum recommended amount of bad fat per day is 22 g and that the user 120 has not yet consumed any bad fat;
area 730e shows that the user's minimum recommended amount of protein per day is 22 g and that the user 120 has not yet consumed any protein; and
area 730f shows that the user's minimum recommended amount of fiber per day is 28 g and that the user 120 has not yet consumed any fiber.

The device 102 may develop the personalized nutrition advice 118 and alternate advice 142 based at least in part on the impact of eating a particular food item on the user's current nutritional intake amounts. For example, the device 102 may advise the user 120 not to eat a particular food item if doing so would cause the user 120 to exceed her or his maximum daily recommended intake of salt.

The values of the nutritional intake parameters may be represented in any units, such as teaspoons, pinches, or grams. Different parameters may be represented in different units from each other.

The maximum values associated with each parameter may be based on demographic data associated with the user 120, such as the user's age, gender, and home address, and on additional personal information, such as the user's weight, height, and level of fitness. The maximum values associated with the user may, for example, be drawn from a database, calculated using a formula, input manually by the user, or any combination thereof. In particular, the system 100 may obtain default values based on the user's demographic data, e.g., from an external source such as the US Department of Agriculture (U.S.D.A.), the Food and Drug Administration (F.D.A.), the Centers for Disease Control and Prevention (C.D.C.), the National Center for Health Statistics, the Institute of Medicine (I.o.M.), the World Health Organization (W.H.O.), or other international organization or governmental body, and then personalize those values for the particular user 120 based on the user's personalized food data 124. For example, if the user 120 has high blood pressure and therefore should have a lower daily salt intake than standard as per the recommendation of the U.S.D.A. or other agency, then the system 100 may assign to the user 120 a lower than standard maximum daily intake amount for salt (e.g., 1 g instead of 2 g).

In one embodiment of the invention, the current value associated with each parameter represents the amount of the parameter (e.g., calories, proteins, fiber, sugar, salt, or bad fat) that the user 120 has consumed so far since the beginning of the current period of time. For example, if the current period of time is today, then the values of all of the parameters may be reset to a default value (e.g., zero) at the beginning of the day (as shown in FIG. 7G). Then, as the user 120 consumes food throughout the day, the system 100 may increase the values of each of the user's battery parameters by amounts corresponding to the contents of the food eaten by the user 120. As a result, the battery associated with the user 120 may indicate, at any particular point during the day, the amount of calories, sugar, salt, and bad fat (for example) that the user 120 has consumed so far during that day.

In another embodiment of the invention, instead of accumulating values upward from zero, the system 100 may instead reset the values of the parameters to their maximum values at the beginning of the day (i.e., in the case of a daily allowance), and reduce the values of the parameters by amounts corresponding to the contents of the food eaten by the user 120. As a result, the battery associated with the user 120 may indicate, at any particular point during the day, the amount of calories, sugar, salt, and bad fat (for example) that the user 120 may still eat during that day before reaching or exceeding the maximum daily recommended amount for the user 120.

The system 100 may display the values of the user's battery parameters to the user 120 at any time and in any way the user 120 requests the system 100 to do so. For example, the system 100 may display textual values of the parameters, or display any kind of chart or other graphic which visually represents the current parameter values. For example, in the embodiment of FIG. 7H, the device 702 displays to the user 120 the impact that eating a cheeseburger would have on the user's battery levels. FIG. 7H shows that eating the cheeseburger would:
cause the user's “calories” battery level to drop by 629 calories to 69% remaining for the day (area 732a);
cause the user's “Sugar” battery level to drop by 1 tsp to 86%% (area 732b);
cause the user's “Salt” battery level to drop by 0.25 tsp to 48% (area 732c);
cause the user's “Bad fat” battery level to drop by 14 grams to 36% (area 732d);
cause the “Protein” battery level to increase by 36 g to 72% of daily target (area 732e); and
cause the “Fiber” battery level to increase by 3.3 g to 12% (area 732f).

The device 102 may, when developing the advice for the user 120, take into account food-related data associated with other users, such as the personalized food data, food intake history, and geographic locations of such users. Similarly, the device 102 may use data associated with the current user 120 to develop food-related advice for other users.

As another example, the user's personalized food data 124 and other user-specific data (such as the user food intake history 126) may be aggregated anonymously (i.e., without personally-identifying information about the user 120) to provide necessary confidentiality. Data collected represents a powerful tool for marketing and research on the actual food intake of registered consumers using the system 100, in a fashion analogous to the Nurses' Health Study and the National Health and Nutrition Examination Survey (NHANES), with the competitive advantage of providing real-time data as opposed to after-the-fact questionnaires with inherent recall biases and systemic errors. Consumer information may be compiled and analyzed according to actual purchases and subsequent consumption of both packaged and fresh food, with associated content including estimated calories, nutrients (food identification data 114), and voluntary food exclusions (e.g. gluten, shellfish, peanuts, dairy, etc.) based on user personalized food data 124.

As mentioned above, the user 120 shown in FIG. 1 may be just one of many users, each of whom has her or his own device of the same kind as that shown in FIG. 1. For example, referring to FIG. 5, a data flow diagram is shown of a system 500 including a plurality of users 520a-c using a plurality of corresponding devices 522a-c according to one embodiment of the invention. Although only three users 520a-c are shown in FIG. 5, this is merely an example and does not constitute a limitation of the present invention. Referring to FIG. 6, a flowchart is shown of a method 600 performed by the system 500 of FIG. 5 according to one embodiment of the present invention.

The users 520a-c may use the corresponding devices 522a-c in any of the ways disclosed above with respect to the user 120 of device 102 in FIG. 1. Therefore, it should be understood that each of the devices 522a-c shown in FIG. 5 may include the components of device 102 shown in FIG. 1, and that each of the users 520a-c shall have her or his own personalized food data 124, food selections 138, food intake history 126, etc., even though these are not shown in FIG. 5 for ease of illustration.

Users 520a-c may share data with each other in any of a variety of ways. For example, users 520a-c may tap their devices 522a-c to each other to cause the devices to exchange data (such as personalized food data 124) with each other wirelessly. The resulting aggregated user data 508 may, for example, be stored on a social networking server 504. Alternatively, for example, the aggregated user data 508 may be stored on two or more of the devices 522a-c, each of which may store a copy of the aggregated data 508. The social networking server 504 may communicate with a food database, such as the food database 122 of FIG. 1, which may include pre-existing food data and/or food data gathered from one or more of the user's devices 522a-c.

Users 520a-c may also share and otherwise communicate data with social networking server 504 over a network 502 (such as the Internet). For example, any food sensed data 106, food identification data 114, food at hand data 136, food intake history 126, user food selection 138, and user personalized food data 124 generated or otherwise obtained by any one of the devices 522a-c may be transmitted by that device to the social networking server 504 over the network 502, where such data may be stored (FIG. 6, step 602). A user data aggregator 506 may aggregate some or all of such data (FIG. 6, step 604). An advice generation module 516 may use such aggregated data 508 to develop (FIG. 6, step 606) and provide advice 518 (FIG. 6, step 608) to one or more of the users 520a-c. Although not expressly shown in FIG. 5, the personalized nutrition advice 518 may be delivered to the specific one of the users 520a-c to whom it is addressed. Furthermore, the server 504 may make a recommendation to a user even if that user did not provide any data to the server 504, and even if the user's device lacks some or all of the capabilities of the device 102 shown in FIG. 1.

The advice generation module 516 may, for example, generate the personalized nutrition advice 518 in any of the ways described above with respect to the advice generation module 116 of FIG. 1, except that the advice generation module 516 of FIG. 5 may generate personalized nutrition advice 518 for a particular one of the users based not only on information related to that user, but also based on information related to other users. In fact, the advice generation module 516 may generate advice for a particular one of the users based solely on information related to other users. Similarly, the advice generation module 116 of FIG. 1 may be modified to generate advice for the user 120 of FIG. 1 using any of the techniques described above, but by further taking into account not only the user-specific information shown in FIG. 1 (e.g., the user's personalized food data 124 and food intake history 126) but also the same kind of information related to other users. Therefore, in practice the same kind of advice generation module may be used as both the advice generation modules 116 in FIG. 1 and the advice generation module 516 in FIG. 5.

In the following examples, the server 504 makes a recommendation to user 522a for purposes of illustration. The server 504 may, for example, recommend that the user 522a eat food that previously has been eaten by users (possibly including the user 522a herself or himself) whose profiles (e.g., personalized food data 124 and/or user food selection 138) are similar to that of the user 522a. The system 500 may determine similarity of user profiles in a number of different ways. Examples of similar profiles are those which specify a preference for a particular kind of food (e.g., meat), those who share a common allergy, or those with similar maximum battery parameter values (e.g. foods with low sodium content). The server 504 may limit its search to food intake histories 126 within a particular window of time (e.g., the previous week, month, or year). For example, if the system determines that a large proportion of users 520a-c who eat spinach wraps or whole wheat bread sandwiches also regularly drink skim milk cappuccino, upon a user 120 presenting a spinach wrap or a whole wheat bread sandwich to be sensed and analyzed by the food sensing and analysis device 102, the personalized nutrition advice 118 may include the advice to try skim milk cappuccino.

The server 504 may identify profiles of users that are similar to the profile of the user 522a, then automatically identify foods that have not been eaten by those users, and then specifically advise the user 522a not to eat such foods. The server 504 may, for example, identify foods which have not been eaten by the other users by identifying foods which do not appear on those user's food intake histories 126, by identifying foods on those users' “excluded foods” lists, or by identifying foods which have adverse health consequences for those users (e.g., allergies or food intolerance).

In one embodiment of the invention, the system 500 introduces rewards, encouraging users 520a-c to compete between each other for the best diet quality score and also for the possibility to earn coupons and discounts on foods that are generated directly and automatically by the food sensing and analysis devices 522a-c, based on the users' personalized food data 124, the users' current locations, and the food at hand 136 for each of the users 520a-c. For example, if the system 500 determines that a large proportion of users 520a-c who eat plain pizza also eat a specific type of ice cream or sorbet, upon a user presenting a plain pizza to be sensed and analyzed by the user's sensing and analysis device, a coupon or discount for such type of ice cream or sorbet may be issued by the system directly (and possibly electronically) to the user.

As another example, assume that user 520a has tapped his device 522a with the device 522b of user 520b. In response, the advice generation module 516 may develop advice 518 which indicates which food(s) are consistent with the personalized food data of both users 520a and 520b. For example, referring to FIG. 7I, assume that device 702 is an implementation of the first user's device 522a. In FIG. 7I, the device 702 displays elements of the personalized food data of the first user 520a in column 736a, and displays corresponding elements of the personalized food data of the second user 520b in column 736b. The device 702 also displays, in area 738, a list of foods (such as foods currently available at the restaurant, grocery store, home, or other establishment at which the users 520a and 520b currently are dining) which are consistent with the personalized food data of both users 520a and 520b, and which are recommended for both users 520a and 520b to eat.

In one embodiment of the present invention, the system 500 may inform a particular user of the number of users in the system 500 who are in the vicinity of the particular user's device and who are currently eating (or recently have eaten) the presented food item 104 being presented by the particular user 120 to the user's device 102, within a range of times specified by the particular user. For example, if user 520a uses her or his device 522a to scan a pizza, the system 500 may inform the user 520a of the number of users within a specified radius (e.g., five miles) of the user 520a who currently are eating pizza or who have eaten pizza within the past 45 minutes.

Although the device 102 shown in FIG. 1 is shown as performing a particular set of functions for a single user, the device 102 may also be configured to perform the same functions for two or more users, each with her/his own personalized food data 124, personalized nutrition advice 118, food intake history 126, etc. Users may identify themselves to the device 102 using a username and password or any other suitable authentication means, so that the device 102 may perform sensing and analysis for the current user based on the appropriate corresponding personalized food data 124 for that user 120.

Various embodiments have been described herein in relation to end users and the devices used by end users. Embodiments of the present invention, however, also have direct applicability to other individuals and entities, such as restaurants and restaurant chains; food retailers and distributors; food services and catering companies; food processors and producers; dietitians and nutritionists; physicians, hospitals, and private practices; health insurers, and researchers and research institutions.

Although such entities may make use of embodiments of the present invention in any of the ways described above, other features of embodiments of the present invention may be particularly useful to particular types of entities. For example, a restaurant may upload its menu (including data describing contents, ingredients, calories, and nutrients, of the menu items represented in any of the ways disclosed above) for storage on a server or elsewhere, and for sharing with end users of the system 500. Such data may be treated by the system 500 as part of the food database 122 (FIG. 1), and thereby used by the system 500 to provide personalized nutrition advice 118 in any of the ways disclosed herein.

In addition to uploading its menu and related information (e.g. ingredients, calories, and nutrients, of the menu items), the system 500 may inform the restaurant (e.g., in real-time or over a set period of time) of how many users of the system 500 are accessing the restaurant's menu, how many and which menu items are being considered for purchase by users, the number and identity of the menu items actually purchased by users. If users authorize their personalized food data 124 to be shared, such data may be aggregated (as disclosed in connection with FIGS. 5 and 6) and shared with the restaurant. For example, the system 500 may inform the restaurant of:
the number of users who have eaten at (or who currently are eating at) the restaurant who prefer to eat seafood, or who will not purchase a particular dish because it contains peanuts;
the number of users who have chosen to purchase or eat less than an entire portion (e.g., half a portion) of a dish and the identity of the dish, thereby enabling the restaurant to track dishes being shared by users and the leftovers being taken home by users, so that the restaurant may consider re-portioning particular dishes to smaller sizes;
the number of users not choosing to eat at the restaurant, along with the actual menu items purchased by such users at other restaurants or other venues.

FIG. 7J illustrates a particular example in which device 702 provides information about a particular food item available for sale by a restaurant, such as:
an image 742 of the food item;
the number of times 744a the food item was considered by patrons of the restaurant within a particular time period 744b; and
the names 746a-c of alternative items sold by competitors of the restaurant, and the numbers of times 748a-c such alternative items were purchased by patrons of those competitors within the same time period 744b.

As another example, a food retailer or distributor may upload an inventory (e.g., in the form of Stock-Keeping Units—or SKUs) being offered for sale at each of its locations for storage on a server or elsewhere, and for sharing with end-users of the system 500. Such data may be treated by the system 500 as part of the food database 122 (FIG. 1), and thereby used by the system 500 to provide personalized nutrition advice to users in any of the ways disclosed herein. Such data may be kept updated at the store level so that when the system 500 provides a user with a recommendation, such a recommendation is based on the food actually being sold at the current time within reach of the user.

In addition to uploading its inventory, the system 500 may provide the food retailer or distributor with information similar to that described above with respect to a restaurant, such as aggregated data indicating, by SKU, which products users considered, rejected, and/or actually purchased from the retailer/distributor. User data may be aggregated and shared with the retailer/distributor in a similar manner to that described above with respect to a restaurant and without disclosing the identity of the users.

As another example, a food services or catering business may upload its menu and other related information about food being offered for sale or serving at each of its locations for storage on a server or elsewhere, and for sharing with end-users of the system 500. Such data may be handled in a manner similar to that described above with respect to restaurants, food retailers and distributors, and used for similar purposes.

As another example, a food/beverage maker/producer may upload individual product information, both for SKU-packaged goods and fresh produce, including nutrition facts, ingredients, and disclaimers (such as tree nut allergen warnings) for storage on a server or elsewhere, and for sharing with end-users of the system 500. Such data may be handled in a manner similar to that described above with respect to restaurants and to food retailers and distributors, and used for similar purposes. Furthermore, aggregated user data may be ranked geographically, and de-identified socio-demographic data (e.g., age, gender, ethnicity) may be stored and analyzed, and made available to the food/beverage maker/producer. In addition to uploading its menu and related information (e.g. ingredients, calories, and nutrients, of the items), the system 500 may inform the food maker/producer (e.g., in real-time or over a set period of time) of how many users of the system 500 are accessing its products, how many and which specific SKU/products are being considered for purchase by users (FIG. 7K, area 750a), the number of SKU/products actually purchased by users (FIG. 7K, area 750b), and the number of items considered but rejected by users (FIG. 7K, area 750c). If users authorize their personalized food data 124 to be shared, such data may be aggregated (as disclosed in connection with FIGS. 5 and 6) and shared with the food maker/producer. For example, the system 500 may inform the food maker/producer of:
the number of users who have not purchased a particular SKU/product because it contains peanuts;
the number of users who have chosen to purchase a similar item from competing offerings;
the number of users not choosing to purchase a SKU/Product of the food maker/producer, along with the actual item information of SKU/Products purchased by such users at other retailers or other distributors.

As another example, dietitians/nutritionists may use the system 500 to upload personalized nutrition advice to their patients, so that such patients may obtain such advice in addition to the advice 518 generated automatically by the system 500. The system 500 may also provide data about the dietitians' and nutritionists' patients to the dietitians and nutritionists, if so authorized by each patient individually, such as by using a user interface of the kind shown in FIG. 7L. The information provided to the nutritionist may include, for example:
the name 752 and photograph 754 of the patient;
personalized food data 124, including, for example, the patient's allergies 760, intolerances 762, preferences 764, and medical conditions 766;
the patients' body mass indices (BMIs), based on weight and height data entered by patients originally and regularly updated (e.g., automatically) for tracking purposes;
the food intake history 126 regarding foods that the patients have been eating and/or rejecting;
a total diet quality score 756 for the patient within a particular date range 758, as generated by the system 500;
the food environments visited by the patients, such as grocery stores, restaurants, vending machines, and school cafeterias;
battery history and indications of how well the patients are keeping their batteries from exceeding their maximum levels or from depleting below their daily allowances as the case may be.

Aggregated user data for the patients of the nutritionists and dietitians may be provided by the system 500 to the nutritionists and dietitians, to allow comparison and benchmarking of progress made by a specific category of patients or individual patients.

As another example, physicians, hospitals, private practices, and any other healthcare providers may use the system 500 to upload personalized nutrition advice to their patients, so that such patients may obtain such advice in addition to the advice 518 generated automatically by the system 500. The system 500 may also provide similar patient data to physicians, hospitals, private practices, and any other healthcare providers, as that described above in connection with nutritionists and dietitians, if and when authorized by those patients/users individually.

As another example, health insurers may be provided with the ability to use the system 500 to provide their members with personalized nutrition guidance generated and transmitted by the system 500.

As yet another example, researchers and institutions (such as universities and government institutions) may obtain access to the aggregated user database 508, properly de-identified, for research purposes.

It is to be understood that although the invention has been described above in terms of particular embodiments, the foregoing embodiments are provided as illustrative only, and do not limit or define the scope of the invention. Various other embodiments, including but not limited to the following, are also within the scope of the claims. For example, elements and components described herein may be further divided into additional components or joined together to form fewer components for performing the same functions.

Any of a variety of functions described herein as being performed by the device 102 or system 100 more generally may be implemented within the user's device 102 or on other devices (e.g., servers operating in clouds), which may communicate with each other and with the user's device 102 using any kind of wired or wireless connection.

The techniques described above may be implemented, for example, in hardware, software tangibly stored on a computer-readable medium, firmware, or any combination thereof. The techniques described above may be implemented in one or more computer programs executing on a programmable computer including a processor, a storage medium readable by the processor (including, for example, volatile and non-volatile memory and/or storage elements), at least one input device, and at least one output device. Program code may be applied to input entered using the input device to perform the functions described and to generate output. The output may be provided to one or more output devices, from a single server or computer or several machines acting in parallel, in series, in clouds, or any system providing very high speed processing.

Each computer program within the scope of the claims below may be implemented in any programming language, such as assembly language, machine language, a high-level procedural programming language, or an object-oriented programming language. The programming language may, for example, be a compiled or interpreted programming language.

Each such computer program may be implemented in a computer program product tangibly embodied in a machine-readable storage device for execution by a computer processor. Method steps of the invention may be performed by a computer processor executing a program tangibly embodied on a computer-readable medium to perform functions of the invention by operating on input and generating output. Suitable processors include, by way of example, both general and special purpose microprocessors. Generally, the processor receives instructions and data from a read-only memory and/or a random access memory. Storage devices suitable for tangibly embodying computer program instructions include, for example, all forms of non-volatile memory, such as semiconductor memory devices, including EPROM, EEPROM, and flash memory devices; magnetic disks such as internal hard disks and removable disks; magneto-optical disks; and CD-ROMs. Any of the foregoing may be supplemented by, or incorporated in, specially-designed ASICs (application-specific integrated circuits) or FPGAs (Field-Programmable Gate Arrays). A computer implementing the techniques described herein can generally also receive programs and data from a storage medium such as an internal disk or a removable disk. These elements will also be found in a conventional desktop or workstation computer as well as other computers and mobile devices suitable for executing computer programs implementing the methods and techniques described herein, which may be used in conjunction with any digital print engine or marking engine, display monitor, or other raster output device capable of producing color or gray scale pixels on paper, film, display screen, or any other output medium.

What is claimed is:

1. A computer-implemented method for use with a device being used by a user, the method comprising:
(1) receiving input from a user representing a presentation from the user of an initial food item within the vicinity of a particular location;
(2) using the device to:
(a) sense the initial food item; and
(b) develop food identification data descriptive of the initial food item; and
(3) developing initial personalized nutrition advice for the user related to the initial food item, based on at least one of:
(a) the food identification data; and
(b) personalized food data associated with the user.

2. The method of claim 1, further comprising:
(4) providing the initial personalized nutrition advice to the user.

3. The method of claim 2, wherein (4) comprises providing the initial personalized nutrition advice to the user using at least one of text, voice, photo, video, light, vibration, and ring tone.

4. The method of claim 2, further comprising:
(5) receiving, from the user, an input indicating whether the user accepts the initial personalized nutrition advice.

5. The method of claim 4, further comprising:
(6) recording the user's input indicating whether the user accepts the initial personalized nutrition advice in a food intake history of the user.

6. The method of claim 4, wherein the user's input indicating whether the user accepts the initial personalized nutrition advice indicates that the user rejects the initial food item, and wherein the method further comprises:
(6) identifying alternative food identification data descriptive of at least one alternative food item within the vicinity of the particular location;
(7) developing alternative personalized nutrition advice for the user related to the at least one alternative food item, based on at least one of:
(a) the alternative food identification data descriptive of the at least one alternative food item; and
(b) the personalized food data associated with the user;
(8) providing the alternative personalized nutrition advice for the at least one alternative food item to the user.

7. The method of claim 6, wherein (6) comprises identifying the at least one alternative food item using data from an external source.

8. The method of claim 7, wherein (6) comprises identifying the at least one alternative food item by:
(6)(a) identifying the current geographic location of the device; and
(6)(b) identifying at least one alternative food item within the vicinity of the current geographic location of the device using an external data source of geo-referenced food data.

9. The method of claim 1, wherein the user presents the initial food item to the device by taking at least one of a picture and a video of the initial food item.

10. The method of claim 1, wherein the user presents the initial food item to the device by reading a bar code associated with the initial food item.

11. The method of claim 1, wherein the user presents the initial food item to the device by reading an RFID tag associated with the initial food item.

12. The method of claim 1, wherein the user presents the initial food item to the device by providing a description of the initial food item to the device.

13. The method of claim 1, wherein (2)(a) comprises sensing the initial food item to obtain food sensed data, and wherein (2)(b) comprises identifying the food identification data based on the food sensed data.

14. The method of claim 1, wherein (2)(a) comprises sensing the initial food item using at least one of the following technologies: Gas chromatography (GC), GC-mass spectrometry (GCMS), mass spectrometry in non-vacuum environment, Atmospheric Pressure Chemical Ionization (APCI), Micro Electro-Mechanical Systems (MEMS), ion mobility spectroscopy, dielectrophoresis, infrared spectroscopy, near-infrared spectroscopy, chemical and conductometric sensors, electronic nose sensors, synthetic olfaction sensors, solid state sensors, Raman sensors, photo analysis, 3D photo modeling, video analysis, biosensors, bio-mimetic systems, photometric sensors, bar code scanning, reading of Radio Frequency Identification (RFID) tags, micro-cantilevers, nano-cantilevers, and any miniaturized equipment developed to smell gas molecules such as volatile organic compounds and peptides.

15. The method of claim 1, wherein (2)(a) comprises sensing the initial food item using at least one of the above technologies in multivariate analysis.

16. The method of claim 1, wherein the initial personalized nutrition advice comprises advice to eat the initial food item.

17. The method of claim 1, wherein the initial personalized nutrition advice comprises advice not to eat the initial food item.

18. The method of claim 1, wherein (3) comprises developing the initial personalized nutrition advice based additionally on a food intake history of the user.

19. The method of claim 18, wherein the food intake history of the user includes a record of food eaten by the user, a record of food rejected by the user, and a record of food leftover by the user after eating a meal.

20. The method of claim 1, wherein (3) comprises developing the initial personalized nutrition advice based additionally on a particular location.

21. The method of claim 20, wherein the particular location comprises a current geographic location of the device.

22. The method of claim 21, wherein (3) further comprises identifying the current geographic location of the device using a global positioning system (GPS) function within the device.

23. The method of claim 20, wherein the particular location comprises a geographic location specified by the user which differs from the current geographic location of the device.

24. The method of claim 1, wherein all components which perform (1)-(3) are contained within the device.

25. The method of claim 1, wherein the personalized food data associated with the user include at least one of allergies, dietary restrictions, medical conditions, taste preferences, and food intolerances associated with the user.

26. The method of claim 1, wherein the personalized food data associated with the user include at least one of the following quantities associated with the user: a minimum amount of calories, a maximum amount of calories, a minimum amount of proteins, a maximum amount of proteins, a minimum amount of fiber, a maximum amount of fiber, a minimum amount of sugar, a maximum amount of sugar, a minimum amount of salt, a maximum amount of salt, a minimum amount of trans fat, a maximum amount of trans fat, a minimum amount of saturated fat, and a maximum amount of saturated fat.

27. The method of claim 1, wherein the initial personalized nutrition advice comprises advice not to eat the initial food item because the initial food item is inconsistent with the personalized food data associated with the user.

28. The method of claim 1, wherein the initial personalized nutrition advice comprises advice to eat the initial food item because the initial food item is consistent with the personalized food data associated with the user.

29. The method of claim 1, further comprising:
(4) providing the user with information about at least one of contents, ingredients, and nutrients of the initial food item.

30. The method of claim 1, wherein (3) comprises:
(3)(a) identifying at least one minimum or maximum personalized periodic nutritional intake amount associated with the user;
(3)(b) determining the impact of the user eating the initial food item on the at least one minimum or maximum personalized periodic nutritional intake amount within a particular period of time; and
(3)(c) developing the initial personalized nutrition advice for the user, indicating whether the user should eat the initial food item, based on the determined impact on the at least one minimum or maximum personalized periodic nutritional intake amount associated with the user.

31. The method of claim 30, wherein the initial personalized nutrition advice indicates what the user's nutritional intake amounts will be for the particular period of time if the user eats the initial food item.

32. The method of claim 30, wherein the initial personalized nutrition advice indicates whether any of the user's periodic nutritional intake amounts will exceed their minimum or maximum, if the user eats the initial food item.

33. The method of claim 30, wherein (3)(c) comprises:
(3)(c)(i) developing initial personalized nutrition advice which advises the user not to eat the initial food item;
(3)(c)(ii) automatically identifying at least one alternative food item; and
(3)(c)(iii) developing alternative personalized nutrition advice which advises the user to eat the at least one alternative food item.

34. The method of claim 30, wherein (3) further comprises:
(3)(d) receiving input from the user indicating that the user has chosen to eat the initial food item; and
(3)(e) updating nutritional intake amounts associated with the particular period of time based on nutrition information associated with the initial food item.

35. The method of claim 30, wherein (3) further comprises:
(3)(d) updating the current values of the user's personalized periodic nutritional intake amounts to reflect physical activity of the user.

36. The method of claim 35, wherein the updating is performed in response to input received from the user.

37. The method of claim 35, wherein the updating is performed without input of the user.

38. The method of claim 37, wherein the updating is performed using a global positioning system (GPS) to track the distance and speed traveled by the user in a particular period of time.

39. The method of claim 30, wherein (3) further comprises:
(3)(d) receiving input from the user indicating that the user has decided not to completely eat the initial food item;
(3)(e) updating the current values of the user's personalized periodic nutritional intake amounts to reflect the quantity of food leftovers of the user.

40. A computer system including at least one processor and at least one computer readable medium tangibly storing computer-readable instructions, wherein the at least one processor is adapted to execute the computer-readable instructions to perform a method for use with a device being used by a user, the method comprising:
(1) receiving input from a user representing a presentation from the user of an initial food item within the vicinity of a particular location;
(2) using the device to:
(c) sense the initial food item; and
(d) develop food identification data descriptive of the initial food item; and
(3) developing initial personalized nutrition advice for the user related to the initial food item, based on at least one of:
(c) the food identification data; and
(d) personalized food data associated with the user.

41. The computer system of claim 40, wherein the method further comprises:
(4) providing the initial personalized nutrition advice to the user.

42. The computer system of claim 41, wherein (4) comprises providing the initial personalized nutrition advice to the user using at least one of text, voice, photo, video, light, vibration, and ring tone.

43. The computer system of claim A41, wherein the method further comprises:
(5) receiving, from the user, an input indicating whether the user accepts the initial personalized nutrition advice.

44. The computer system of claim 43, wherein the method further comprises:
(6) recording the user's input indicating whether the user accepts the initial personalized nutrition advice in a food intake history of the user.

45. The computer system of claim 43, wherein the user's input indicating whether the user accepts the initial personalized nutrition advice indicates that the user rejects the initial food item, and wherein the method further comprises:
(6) identifying alternative food identification data descriptive of at least one alternative food item within the vicinity of the particular location;
(7) developing alternative personalized nutrition advice for the user related to the at least one alternative food item, based on at least one of:
(c) the alternative food identification data descriptive of the at least one alternative food item; and
(d) the personalized food data associated with the user;
(8) providing the alternative personalized nutrition advice for the at least one alternative food item to the user.

46. The computer system of claim 45, wherein (6) comprises identifying the at least one alternative food item using data from an external source.

47. The computer system of claim 46, wherein (6) comprises identifying the at least one alternative food item by:
(6)(a) identifying the current geographic location of the device; and
(6)(b) identifying at least one alternative food item within the vicinity of the current geographic location of the device using an external data source of geo-referenced food data.

48. The computer system of claim 40, wherein the user presents the initial food item to the device by taking at least one of a picture and a video of the initial food item.

49. The computer system of claim 40, wherein the user presents the initial food item to the device by reading a bar code associated with the initial food item.

50. The computer system of claim 40, wherein the user presents the initial food item to the device by reading an RFID tag associated with the initial food item.

51. The computer system of claim 40, wherein the user presents the initial food item to the device by providing a description of the initial food item to the device.

52. The computer system of claim 40, wherein (2)(a) comprises sensing the initial food item to obtain food sensed data, and wherein (2)(b) comprises identifying the food identification data based on the food sensed data.

53. The computer system of claim 40, wherein (2)(a) comprises sensing the initial food item using at least one of the following technologies: Gas chromatography (GC), GC-mass spectrometry (GCMS), mass spectrometry in non-vacuum environment, Atmospheric Pressure Chemical Ionization (APCI), Micro Electro-Mechanical Systems (MEMS), ion mobility spectroscopy, dielectrophoresis, infrared spectroscopy, near-infrared spectroscopy, chemical and conductometric sensors, electronic nose sensors, synthetic olfaction sensors, solid state sensors, Raman sensors, photo analysis, 3D photo modeling, video analysis, biosensors, bio-mimetic systems, photometric sensors, bar code scanning, reading of Radio Frequency Identification (RFID) tags, micro-cantilevers, nano-cantilevers, and any miniaturized equipment developed to smell gas molecules such as volatile organic compounds and peptides.

54. The computer system of claim 40, wherein (2)(a) comprises sensing the initial food item using at least one of the above technologies in multivariate analysis.

55. The computer system of claim 40, wherein the initial personalized nutrition advice comprises advice to eat the initial food item.

56. The computer system of claim 40, wherein the initial personalized nutrition advice comprises advice not to eat the initial food item.

57. The computer system of claim 40, wherein (3) comprises developing the initial personalized nutrition advice based additionally on a food intake history of the user.

58. The computer system of claim 57, wherein the food intake history of the user includes a record of food eaten by the user, a record of food rejected by the user, and a record of food leftover by the user after eating a meal.

59. The computer system of claim 40, wherein (3) comprises developing the initial personalized nutrition advice based additionally on a particular location.

60. The computer system of claim 59, wherein the particular location comprises a current geographic location of the device.

61. The computer system of claim 60, wherein (3) further comprises identifying the current geographic location of the device using a global positioning system (GPS) function within the device.

62. The computer system of claim 59, wherein the particular location comprises a geographic location specified by the user which differs from the current geographic location of the device.

63. The computer system of claim 40, wherein all components which perform (1)-(3) are contained within the device.

64. The computer system of claim 40, wherein the personalized food data associated with the user include at least one of allergies, dietary restrictions, medical conditions, taste preferences, and food intolerances associated with the user.

65. The computer system of claim 40, wherein the personalized food data associated with the user include at least one of the following quantities associated with the user: a minimum amount of calories, a maximum amount of calories, a minimum amount of proteins, a maximum amount of proteins, a minimum amount of fiber, a maximum amount of fiber, a minimum amount of sugar, a maximum amount of sugar, a minimum amount of salt, a maximum amount of salt, a minimum amount of trans fat, a maximum amount of trans fat, a minimum amount of saturated fat, and a maximum amount of saturated fat.

66. The computer system of claim 40, wherein the initial personalized nutrition advice comprises advice not to eat the initial food item because the initial food item is inconsistent with the personalized food data associated with the user.

67. The computer system of claim 40, wherein the initial personalized nutrition advice comprises advice to eat the initial food item because the initial food item is consistent with the personalized food data associated with the user.

68. The computer system of claim 40, wherein the method further comprises:
(4) providing the user with information about at least one of contents, ingredients, and nutrients of the initial food item.

69. The computer system of claim 40, wherein (3) comprises:
(3)(a) identifying at least one minimum or maximum personalized periodic nutritional intake amount associated with the user;
(3)(b) determining the impact of the user eating the initial food item on the at least one minimum or maximum personalized periodic nutritional intake amount within a particular period of time; and
(3)(c) developing the initial personalized nutrition advice for the user, indicating whether the user should eat the initial food item, based on the determined impact on the at least one minimum or maximum personalized periodic nutritional intake amount associated with the user.

70. The computer system of claim 69, wherein the initial personalized nutrition advice indicates what the user's nutritional intake amounts will be for the particular period of time if the user eats the initial food item.

71. The computer system of claim 69, wherein the initial personalized nutrition advice indicates whether any of the user's periodic nutritional intake amounts will exceed their minimum or maximum, if the user eats the initial food item.

72. The computer system of claim 69, wherein (3)(c) comprises:
(3)(c)(i) developing initial personalized nutrition advice which advises the user not to eat the initial food item;
(3)(c)(ii) automatically identifying at least one alternative food item; and
(3)(c)(iii) developing alternative personalized nutrition advice which advises the user to eat the at least one alternative food item.

73. The computer system of claim 69, wherein (3) further comprises:
(3)(d) receiving input from the user indicating that the user has chosen to eat the initial food item; and
(3)(e) updating nutritional intake amounts associated with the particular period of time based on nutrition information associated with the initial food item.

74. The computer system of claim 69, wherein (3) further comprises:
(3)(d) updating the current values of the user's personalized periodic nutritional intake amounts to reflect physical activity of the user.

75. The computer system of claim 74, wherein the updating is performed in response to input received from the user.

76. The computer system of claim 74, wherein the updating is performed without input of the user.

77. The computer system of claim 76, wherein the updating is performed using a global positioning system (GPS) to track the distance and speed traveled by the user in a particular period of time.

78. The computer system of claim 69, wherein (3) further comprises:
(3)(d) receiving input from the user indicating that the user has decided not to completely eat the initial food item;
(3)(e) updating the current values of the user's personalized periodic nutritional intake amounts to reflect the quantity of food leftovers of the user.

79. A computer-implemented method comprising:
(1) identifying first personalized food data of a first user associated with a first device;
(2) identifying second personalized food data of at least one second user associated with at least one second device; and
(3) developing, based on the first and second personalized food data, a database containing data representing the first personalized food data and the second personalized food data.

80. The method of claim 79, further comprising:
(4) developing, based on the database, personalized nutrition advice associated with the first user.

81. The method of claim 80, wherein the advice is developed in (4) by:
(4)(a) identifying a subset of the second users whose personalized food data are similar to the first user's personalized food data;
(4)(b) identifying a first food item indicated as preferred by the personalized food data of the subset of the second users; and
(4)(c) advising the first user to eat the identified first food item.

82. The method of claim 80, wherein the advice is developed in (4) by:
(4)(a) identifying a subset of the second users whose personalized food data are similar to the first user's personalized food data;
(4)(b) identifying a first food item indicated as not preferred by the personalized food data of the subset of the second users; and
(4)(c) advising the first user not to eat the identified first food item.

83. The method of claim 80, wherein the advice is developed in (4) based on both the database and food intake history of at least one of the users reflected in the database.

84. The method of claim 83, wherein the advice is developed in (4) by:
(4)(a) identifying a first food item previously eaten by the second users; and
(4)(b) advising the first user to eat the first food item.

85. The method of claim 83, wherein the advice is developed in (4) by:
(4)(a) identifying a first food item not previously eaten by the second users; and
(4)(b) advising the first user not to eat the first food item.

86. The method of claim 79, wherein (3) includes transmitting the first and second personalized food data between the first and second devices.

87. The method of claim 79, wherein (3) includes transmitting the first and second personalized food preferences to a server.

88. The method of claim 79, wherein each user may specify restrictions on which other users may access the user's personalized food data.

89. The method of claim 79, further comprising modifying a menu based on the first and second personalized food data.

90. The method of claim 79, further comprising modifying a meal based on the first and second personalized food data.

91. The method of claim 80, wherein the advice is developed in (4) based on both the database and geographic locations of at least one of the users reflected in the database.

92. The method of claim 91, wherein the advice is developed in (4) by:
(4)(a) identifying second users whose geographic locations are within the vicinity of a particular location;
(4) (b) identifying a first food item previously eaten by the second users; and
(4) (c) advising the first user to eat the identified first food item.

93. The method of claim 92, wherein the particular location comprises a current geographic location of the first device.

94. The method of claim 93, wherein the particular location comprises a geographic location specified by the first user.

95. The method of claim 91, wherein the advice is developed in (4) by:
(4)(a) identifying second users whose geographic locations are within the vicinity of the particular location;
(4)(b) identifying a first food item not previously eaten by the second users; and
(4)(c) advising the first user not to eat the identified first food item.

96. A computer system including at least one processor and at least one computer readable medium tangibly storing computer-readable instructions, wherein the at least one processor is adapted to execute the computer-readable instructions to perform a method comprising:
(1) identifying first personalized food data of a first user associated with a first device;
(2) identifying second personalized food data of at least one second user associated with at least one second device; and
(3) developing, based on the first and second personalized food data, a database containing data representing the first personalized food data and the second personalized food data.

97. The computer system of claim 96, wherein the method further comprises:
(4) developing, based on the database, personalized nutrition advice associated with the first user.

98. The computer system of claim 97, wherein the advice is developed in (4) by:
(4)(a) identifying a subset of the second users whose personalized food data are similar to the first user's personalized food data;
(4)(b) identifying a first food item indicated as preferred by the personalized food data of the subset of the second users; and
(4)(c) advising the first user to eat the identified first food item.

99. The computer system of claim 97, wherein the advice is developed in (4) by:
(4)(a) identifying a subset of the second users whose personalized food data are similar to the first user's personalized food data;
(4)(b) identifying a first food item indicated as not preferred by the personalized food data of the subset of the second users; and
(4)(c) advising the first user not to eat the identified first food item.

100. The computer system of claim 97, wherein the advice is developed in (4) based on both the database and food intake history of at least one of the users reflected in the database.

101. The computer system of claim 100, wherein the advice is developed in (4) by:
(4)(a) identifying a first food item previously eaten by the second users; and
(4)(b) advising the first user to eat the first food item.

102. The computer system of claim 100, wherein the advice is developed in (4) by:
(4)(a) identifying a first food item not previously eaten by the second users; and
(4)(b) advising the first user not to eat the first food item.

103. The computer system of claim 96, wherein (3) includes transmitting the first and second personalized food data between the first and second devices.

104. The computer system of claim 96, wherein (3) includes transmitting the first and second personalized food preferences to a server.

105. The computer system of claim 96, wherein each user may specify restrictions on which other users may access the user's personalized food data.

106. The computer system of claim 96, wherein the method further comprises modifying a menu based on the first and second personalized food data.

107. The computer system of claim 96, wherein the method further comprises modifying a meal based on the first and second personalized food data.

108. The computer system of claim 97, wherein the advice is developed in (4) based on both the database and geographic locations of at least one of the users reflected in the database.

109. The computer system of claim 108, wherein the advice is developed in (4) by:
(4)(a) identifying second users whose geographic locations are within the vicinity of a particular location;
(4)(b) identifying a first food item previously eaten by the second users; and
(4)(c) advising the first user to eat the identified first food item.

110. The computer system of claim 109, wherein the particular location comprises a current geographic location of the first device.

111. The computer system of claim 109, wherein the particular location comprises a geographic location specified by the first user.

112. The computer system of claim 108, wherein the advice is developed in (4) by:
(4)(a) identifying second users whose geographic locations are within the vicinity of the particular location;
(4)(b) identifying a first food item not previously eaten by the second users; and
(4)(c) advising the first user not to eat the identified first food item.
